(19) United States
(12) Patent Application Publication
(10) Pub. No.: US 2008/0298382 A1
(43) Pub. Date: Dec. 4, 2008

(54) METHOD, APPARATUS AND SYSTEM FOR PROGRESSIVE REFINEMENTOF CHANNEL ESTIMATION TO INCREASE NETWORK DATA THROUGHPUT AND RELIABILITY

(75) Inventors: Stefano GALLI, Morristown, NJ (US); Hisao KOGA, Fukuoka (JP)

Correspondence Address: DICKINSON WRIGHT PLLC, 1901 L STREET NW, SUITE 800, WASHINGTON, DC, 20036, US

(73) Assignee: MATSUSHITA ELECTRIC INDUSTRIAL CO., LTD., OSAKA (JP)

(21) Appl. No.: 11/756,121

(22) Filed: May 31, 2007

(51) Int. Cl. H04N 11/02

(52) U.S. Cl. 370/438

(57) ABSTRACT

A communication method and device operates in a network in which a multiplicity of communication devices communicate over a shared communication channel. The communication device includes a transmitter that transmits to a second communication device over the shared communication channel a first packet P1, employing a starting tone map TMS that includes a starting transmission scheme for a set of carriers of said channel, a receiver that receives over the shared channel a partial tone map PTM1 from the second communication device, and a tone map generator that generates an updated tone map TM1 based on the starting tone map TMS modified in accordance with the partial tone map PTM1. The transmitter transmits over the shared channel a second packet P2 to the second communication device, employing the updated tone map TM1. The partial tone map may be received as part of an acknowledgment packet from the second communication device.

### FIELD OF THE INVENTION

The invention relates to high speed communications using a communications medium such as an Alternating Current (AC) or Direct Current (DC) power line and employing dynamic channel estimation.

### DESCRIPTION OF RELATED ART

Conventional techniques for dealing with the problem of power line channel estimation are described in five patent applications, which are hereby incorporated by reference:

(1) US 2005/0190785 A1, by Yonge et al., filed Feb. 26, 2004,
(2) US 2004/0070912 A1, by Kopp, filed Sep. 30, 2002,
(3) US 2005/0037722 A1, by Koga et al., filed Feb. 17, 2005,
(4) US 2005/0238109 A1, by Koga et al., filed Oct. 27, 2005, and
(5) US 2005/0238089 A1, by Kodama et al., filed Oct. 27, 2005. The power line estimation techniques described by Yonge and Kopp are based on very similar principles, while those of Koga and Kodama are based on another channel estimation procedure.

### SUMMARY OF THE INVENTION

The present invention provides an improved channel estimation and adaptation technique by feeding back a partial tone map or an indicator thereof transmitted on an acknowledgment (e.g., ACK or NACK) packet in a feedback channel, in order to update a tone-map of an adaptive transmission scheme. A tone map is a set of transmission parameters that can be used on a link in order to achieve high data rates. The optimal tone map for a given carrier is the one that is capable of achieving a high data rate based on the existing channel conditions which are estimated in accordance with characteristics such as channel attenuation characteristics (or equivalently, the channel impulse response) and local noise characteristics. Tone maps include parameters such as the carrier frequency, sub-carrier frequencies, modulation type, coding type and rate, Forward Error-Correction (FEC) coding rate, etc. To maximize the data rate between various links, the communication stations adjust their transmission parameters dynamically in both time and frequency. The invention progressively refines the channel estimation and enables transmission of packets at optimal time instants. Some non-limiting, exemplary and preferred aspects of the invention are discussed below.

A communication device for communicating over a communication channel may include a transmitter that transmits over the channel to a second communication device a first packet P1, employing a starting tone map TMS comprising a starting transmission scheme for a set of carriers of the channel; a receiver that receives over the channel a partial tone map PTM1 or an indicator thereof from the second communication device; and a tone map generator that generates an updated tone map TM1 based on the starting tone map TMS and the partial tone map PTM1 or the indicator thereof, wherein the transmitter transmits over the channel a second packet P2 to the second communication device, employing the updated tone map TM1. The communication device may further comprise a memory that stores a partial tone map PTM1, wherein the tone map generator retrieves the partial tone map PTM1 from the memory based on the indicator of partial tone map PTM1 and modifies the starting tone map TMS with information of the partial tone map PTM1. The partial tone map PTM1 or the indicator thereof may be received as part of an acknowledgment packet from the second communication device.

A method and system of communicating over a communication medium having a periodically varying channel may include determining a starting tone map TMS comprising a starting transmission scheme for a set of carriers of the channel; transmitting at the first communication device a first packet P1 employing the starting tone map TMS; receiving the first packet P1 at a second communication device; determining a tone map TMO1 based on characteristics of the packet P1 received at the second communication device, the tone map TMO1 comprising transmission schemes for the set of carriers of the channel; comparing the tone map TMO1 with the starting tone map TMS to determine a partial tone map PTM1 comprising transmission schemes for a subset of the carriers of the channel that are different from the starting transmission scheme of the starting tone map TMS; generating an updated tone map TM1 based on the starting tone map TMS modified in accordance with the partial tone map PTM1; associating the updated tone map TM1 with a time offset To1 between a start time of a communication period and a start time of the first packet P1 and a time value Tp1 comprising a time duration to transmit the first packet P1; and employing the updated tone map TM1 to transmit at the first communication device a packet to the second communication device. The packet transmitted by employing the updated tone map TM1 may have a time duration equal to the time value Tp1 and may be transmitted at a time offset from the start time of the communication period equal to the time value To1+j×L, where j is an integer and L is a variation cycle of characteristics of the periodically varying channel. In ideal conditions, the updated tone map TM1 is employed to transmit at the first communication device a packet having a time offset from the start time of the communication period equal to the time value To1+j×L, where j is an integer. However, the time offset need not always be equal to this time value To1+j×L. That is, some deviation from this nominal value is inevitable for several reasons. For example, the AC cycle is only nominally equal to L, e.g. 1/L=50 Hz or 1/L=60 Hz, and deviations from these nominal values are often encountered in practice. Moreover, some delay or inaccuracy is always involved when recording the exact start of the transmission of a packet or of a communications period. For these reasons, in a practical system, packets will be transmitted at time instants that will deviate from the nominal optimal time instant To1+j×L. However, if this deviation is small, then only a small compensation to the optimal transmission scheme is needed, and this compensation can be efficiently carried out by the use of partial tone maps as described in this invention. The scheme may further comprise transmitting at the first communication device a second packet P2 employing the starting tone map TMS; receiving the second packet P2 at the second communication device; determining a tone map TMO2 based on characteristics of the second packet P2 received at the second communication device, the tone map TMO2 comprising transmission schemes for the set of carriers of the channel; comparing the tone map TMO2 with the starting tone map TMS to determine a partial tone map PTM2 comprising transmission schemes for a subset of the carriers of the channel that are different from the starting transmission scheme of the starting tone map TMS; generating an updated tone map TM2 based on the starting tone map TMS modified in accordance with the partial tone map PTM2; associating the updated tone map TM2 with a time offset To2 between a start time of the communication period and a start time of the second packet P2 and a time value Tp2 comprising a time duration to transmit the second packet P2; and employing the updated tone map TM2 to transmit a packet to the second communication device. The packet transmitted by employing the updated tone map TM2 has a time duration equal to the time value Tp2 and is transmitted at a time offset from the start time of the communication period equal to To2+j×L. The scheme may further comprise transmitting at the first communication device another packet P employing the updated tone map TM1; receiving the packet P at the second communication device; determining a tone map TMO based on characteristics of the packet P received at the second communication device, the tone map TMO comprising transmission schemes for the set of carriers of the channel; comparing the tone map TMO with the tone map TM1 to determine a partial tone map PTM comprising transmission schemes for a subset of the carriers of the channel that are different from the transmission scheme of the tone map TM1; updating the tone map TM1 based on the partial tone map PTM to generate an updated tone map TM; associating the updated tone map TM with the time offset To1 and the time value Tp1; and employing the updated tone map TM to transmit at the first communication device a packet to the second communication device. The packet transmitted by employing the updated tone map TM may have a time duration equal to the time value Tp1 and may be transmitted at a time offset from the start time of the communication period equal to the time value To1+(j+1)×L.

A method and system of communicating over a communication channel may comprise determining a starting tone map TMS comprising a starting transmission scheme for a set of carriers of the channel; transmitting at the first communication device a packet P1 employing the starting tone map TMS; receiving the packet P1 at a second communication device; determining a tone map TMO1 based on characteristics of the packet P1 received at the second communication device, the tone map TMO1 comprising transmission schemes for the set of carriers of the channel; comparing the tone map TMO1 with the starting tone map TMS to determine a partial tone map PTM1 comprising transmission schemes for a subset of the carriers of the channel that are different from the starting transmission scheme of the starting tone map TMS; transmitting the partial tone map PTM1 or an indicator thereof to the first communication device; generating an updated tone map TM1 based on the starting tone map TMS modified in accordance with the partial tone map PTM1; and employing the updated tone map TM1 to transmit a packet at the first communication device. The method may further comprise transmitting at the first communication device another packet P employing the updated tone map TM1; receiving the packet P at a second communication device; determining a tone map TMO based on characteristics of the packet P received at the second communication device, the tone map TMO comprising transmission schemes for the set of carriers of the channel; comparing the tone map TMO with the tone map TM1 to determine a partial tone map PTM comprising transmission schemes for a subset of the carriers of the channel that are different from the transmission scheme of the tone map TM1; updating the tone map TM1 based on the partial tone map PTM to generate an updated tone map TM; and employing the updated tone map TM to transmit a packet at the first communication device.

### BRIEF DESCRIPTION OF THE DRAWINGS

The accompanying drawings, which are incorporated in and constitute a part of the specification, illustrate presently preferred non-limiting examples of exemplary embodiments of the invention, and, together with the general description given above and the detailed description of the preferred embodiments given below, serve to explain the principles and concepts of the invention, in which like reference characters designate like or corresponding parts throughout the several drawings.

FIG. 1 illustrates a communication system that implements embodiments of the invention.

FIG. 2 illustrates an apparatus of a node illustrated in FIG. 1.

FIG. 3 illustrates the communication of packets over a network channel, having an AC signal component, for a case where data and ACK packets are the same size.

FIG. 4 illustrates the communication of packets over a network channel, having an AC signal component, for a case where data and ACK packets are different sizes.

FIG. 5 illustrates packet communication between two nodes in a DC network.

FIG. 6 illustrates a receiving section of a network node.

FIG. 7 illustrates an example of how tone maps TMs may be selected on the basis of a set of CINR thresholds.

FIG. 8 illustrates an example of a related art ACK packet.

FIG. 9 illustrates an acknowledgment packet augmented with a variable length field.

FIG. 10 illustrates a packet structure for communicating tone map information.

FIG. 11 illustrates components of a data packet's header.

FIGS. 12A and 12B illustrate noise spread of a received signal with respect to reference points of a modulation constellation.

FIGS. 13A and 13B illustrate partial channel estimate (CE) maps.

FIG. 14 illustrates a data packet having a postamble.

FIG. 15 illustrates a data packet having pilot signals spaced across its length.

FIG. 16 illustrates computing a moving average of sub-carrier SNR for a packet stream.

FIG. 17 illustrates applying packets of varying lengths to a communication channel having a time-varying characteristic. and

FIG. 18 illustrates applying multiple tone maps to the transmission of a data packet in a channel having a time-varying characteristic.

FIG. 19 illustrates a method of applying a tone map to a communication channel having a cyclically time-varying characteristic.

FIGS. 20A and 20B illustrate a method flow chart of another embodiment of the invention in which two network nodes are communicating.

FIGS. 21A-21C illustrate a method flow chart of another embodiment of the invention.

FIG. 22 illustrates a method flow chart of another embodiment of the invention.

FIGS. 23A-23C illustrate a method flow chart of another embodiment of the invention.

### DETAILED DESCRIPTION

Reference will now be made in detail to the presently non-limiting, exemplary and preferred embodiments of the invention as illustrated in the accompanying drawings. The nature, concepts, objectives and advantages of the present invention will become more apparent to those skilled in the art after considering the following detailed description in connection with the accompanying drawings. The following description is provided in order to explain preferred embodiments of the present invention, with the particular features and details shown therein being by way of non-limiting illustrative examples of various embodiments of the present invention. The particular features and details are presented with the goal of providing what is believed to be the most useful and readily understood description of the principles and conceptual versions of the present invention. In this regard, no attempt is made to show structural details of the invention in more detail than is necessary for the fundamental understanding of the present invention. The detailed description considered with the appended drawings are intended to make apparent to those skilled in the art how the several forms of the present invention may be embodied in practice.

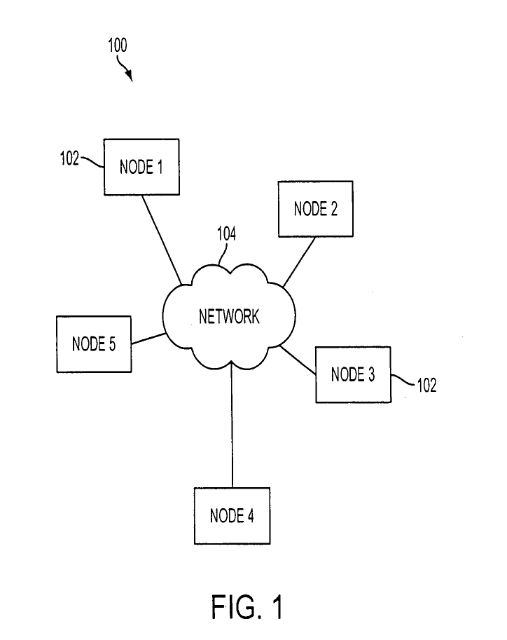

FIG. 1 illustrates a communication system 100 that implements embodiments of the invention. System 100 includes multiple communication nodes (communication devices) 102 that communicate through a network 104.

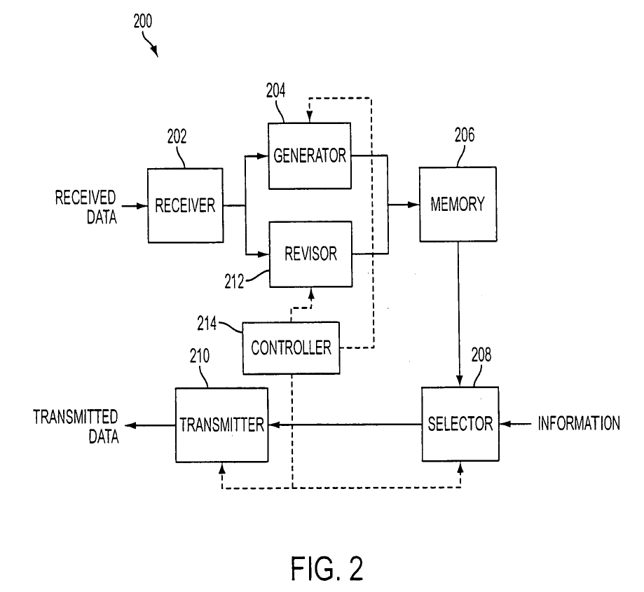

FIG. 2 illustrates an apparatus of nodes 102. Communication apparatus 200 includes a receiver 202 that receives, from another network node, a channel estimate indicator regarding an initial period of communication over a channel having a time-varying characteristic (e.g., quality). A generator 204 generates a tone map in accordance with the received channel estimate indicator and stores the generated tone map in association with an indicator of the initial period in a memory 206. The tone map may include parameter information to be applied to a subsequent transmission by communication apparatus 200, such as the carrier frequency, sub-carrier frequencies, modulation type, coding type and rate, Forward Error-Correction (FEC) coding rate, etc.

A selector 208 selects the stored tone map for communicating information over the channel during a subsequent period when the channel communication characteristic is expected to be similar to that which occurred during the initial period. A transmitter 210 communicates the information over the channel during the subsequent period using the selected tone map. A tone map revisor 212 revises the selected tone map based on a partial tone map derived from a channel estimate determined by the other node, from reception of the information, and communicated to revisor 212 through receiver 202. Memory 206 stores the revised tone map in association with the indicator of the initial period or the period in which the information was transmitted. A controller 214 controls the operation of generator 204, selector 208, transmitter 210, and revisor 214 to generate and revise multiple tone maps and partial tone maps for each of a plurality of initial and subsequent periods.

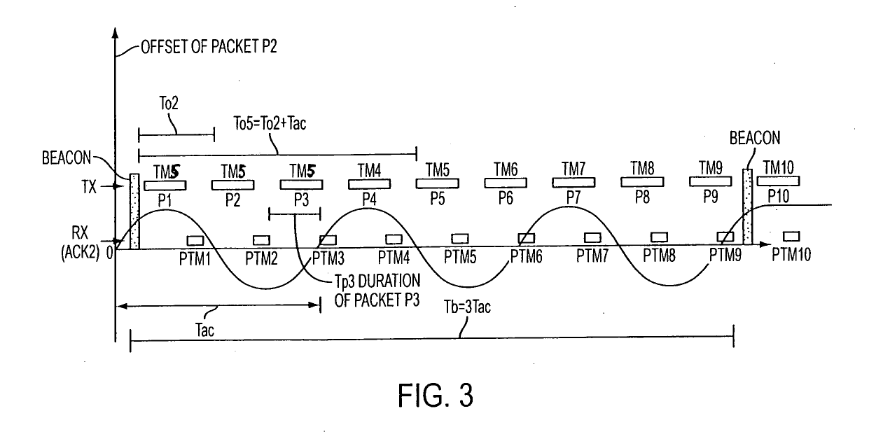

FIG. 3 illustrates the communication of packets over a network channel, having an AC signal component, for a case where data and ACK packets are the same size. This is a very simple case that is well suited for Time Division Multiple Access (TDMA) or contention-free multiple access communication. In this case, it possible to choose the length of the data and ACK packets so that an integer number of packets fit within an AC cycle or a beacon interval. To better understand the method, Table 1 below provides a specific example of how the tone maps are generated and applied to the packets of FIG. 3 transmitted from a first communication device (TX) to a second communication device (RX). It should be understood that both the first and second communication devices each include a transmitter, a receiver, and a tone map generator, so that each may operate in turn as TX or RX in the FIG. 3 illustration. The Tone Map Start (TMS) identified in Table 1 may be a packet carrying data (e.g., data unknown to the receiver) that is robustly modulated or a packet carrying a special training sequence that is known to the receiver so as to improve the accuracy of the channel estimation.

TABLE 1
Example of Three Periodic Packet Transmissions per AC Cycle

| | | | Information |
|---|---|---|---|
| | | Acknowl- | in |
| Packet | Applied Tone Map | edgment | Acknowledgment |
| RCE₁, RCE₂, | | CER | TMS |
| & RCE₃ | | | |
| P₁ | TMS | ACK₁ | PTM₁ |
| P₂ | TMS | ACK₂ | PTM₂ |
| P₃ | TMS | ACK₃ | PTM₃ |
| P₄ | TM₄ = TMS + PTM₁ | ACK₄ | PTM₄ |
| P₅ | TM₅ = TMS + PTM₂ | ACK₅ | PTM₅ |
| P₆ | TM₆ = TMS + PTM₃ | ACK₆ | PTM₆ |
| P₇ | TM₇ = TM₄ + PTM₄ | ACK₇ | PTM₇ |
| P₈ | TM₈ = TM₅ + PTM₅ | ACK₈ | PTM₈ |
| P₉ | TM₉ = TM₆ + PTM₆ | ACK₉ | PTM₉ |
| P₁₀ | TM₁₀ = TM₇ + PTM₇ | ACK₁₀ | PTM₁₀ |

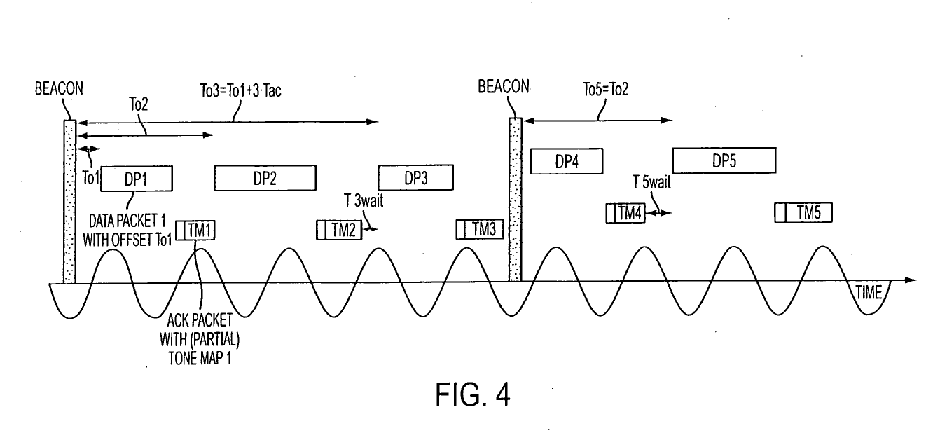

FIG. 4 illustrates the communication of packets over a network channel, having an AC signal component, for a case where data and ACK packets have different sizes. Dynamic channel estimation may be applied to such a case. Also, this case may be suited to scenarios based on multiple access with contention, since the transmitter may have to wait an amount of time T_{wait} in order to transmit its packet at a suitable time, which is based on the time offset of the packet sent in the previous AC cycle and the AC cycle period.

For example, as illustrated in FIG. 4, packet DP3 is transmitted at time offset To3 from the beacon. If the relationship To3=To1+3·Tac holds, then the preferred TM(DP3) to be used for transmitting DP3 is the TM(DP1) used to transmit DP1 plus the correction TM1 contained in the ACK packet of DP1. Since packet lengths are not fixed, it is possible that the transmitter may be ready to transmit DP3 before To3. The transmitter may either transmit immediately (earlier than To3), or decide to wait a time T_{3wait} in order to transmit at To3=To1+3·Tac. If T_{3wait} is small, then it is convenient to wait so that overall throughput efficiency is not degraded. The same methodology may be applied to packets transmitted in a different beacon interval, as in the case of DP5. If T_{5wait} is small, it may be worth waiting to transmit DP5 at time offset from the beacon To5=To2 so that the preferred TM(DP5)=TM(DP2)+TM2 can be used.

The following three cases are discussed below: (1) the beacon interval Tb is equal to an integer multiple of the AC cycle; (2) Tb is not equal to an integer multiple of the AC cycle; and (3) DC-based networks.

First, consider the situation when the beacon interval is an integer multiple of an AC cycle existing in the communication channel. For example, when the AC cycle is 60 Hz, the beacon interval would be Tb=50 ms=3·Tac. The beacon can start with any offset with respect to the AC zero crossing.

Given the periodicity of channel and noise conditions, TMᵢ (i=1, . . . , 4) is a preferred tone map TM for packets that have duration Tpᵢ and are being transmitted at an offset of Toⱼ=Toᵢ+j·Tac (i=1, 2, 3, 4; j=1, 2, 3, . . . ). Therefore, the transmitter selects the best tone map TM among the four available ones on the basis of when the packet of duration Tpᵢ is going to be transmitted, i.e., on the basis of the time offset from the beacon start. Every time a packet is transmitted, a partial tone map PTM is fed back with the ACK packet so that the tone maps TMᵢ always get refined; the extent of the refinement tends to decrease at every iteration so that smaller and smaller tone map improvements get fed back at every iteration.

After a few refinements, the improved TMᵢ will tend to converge to a desired tone map TMOᵢ. Once desired tone maps are obtained and no changes in the link occur, then no more partial tone map PTMs are fed back to the transmitter. At this point, the transmitter can also try to increase the PHY rate by selecting a weaker FEC or by increasing the packet duration, if the receiver signals (in the ACK packet) that no or very few errors have occurred. The tendency to converge holds true even if Toⱼ is larger than Tb, i.e., convergence holds even in successive beacon intervals. Thus, a high PHY rate and transmission efficiency are quickly achieved.

If sudden variations of the channel occur (i.e., a noisy appliance being plugged-in or disconnected, appliances switched on or off, etc.), the receiver will re-start the progressive update of the transmitter utilizing a partial tone map PTM in the ACK packets. Alternatively, the receiver may request the use of a stronger or weaker FEC or may instruct the transmitter to change the packet duration.

Next, consider the case in which the beacon interval is not an integer multiple of the AC cycle. For example, the beacon interval may be approximately 2.9 or 2.4 times the AC cycle (i.e., 23/8=2.875 when AC cycle is 60 Hz and 2.39583 when AC cycle is 50 Hz). The length of Tb may be specified and the beacon can start with any offset with respect to the AC zero crossing.

However, if Tb is not an exact multiple integer of the AC cycle, then a steady state of convergence is not necessarily achieved since the convergence of a tone map does not necessarily hold outside the current beacon interval. The further away the ratio of Tb/Tac is from an integer number, the more refinement the tone map may need from one beacon interval to another. But convergence of a tone map is maintained within the same beacon interval and this can be exploited since a beacon interval typically contains several half AC cycles.

In a case where packet offsets are determined with respect to the most recent beacon, a node transmitting packets may adjust previously determined time offset values used in previous beacon intervals. Such an adjustment is useful because the beacon is not an integer multiple of the AC cycle period. This adjustment may be accomplished as follows.

Every time a beacon is detected, a node sets its internal timer to a value of zero. For example, where node 1 will communicate packets to node 2, node 1 may initiate the generation of tone maps at the 0^{th} beacon interval, which has time duration T_{B}. For each packet transmission, node 1 stores the value of an internal timer at the start of the packet transmission; this value is the time offset T₀^{(0,1)} between the start of the packet transmission and the last beacon. T₀^{(j,i)} represents the time offset of the i^{th} packet transmitted during the j^{th} beacon interval. At every new beacon, node 1 adjusts the time offset value used in the previous beacon interval using the following equations:

$${T}_{0}^{( j , i )} = \{ \begin{matrix}ϑ ( j - 1 , i ) , & if ϑ ( j - 1 , i ) \neq 0 \\ L , & if ϑ ( j - 1 , i ) = 0\end{matrix} \\ ϑ ( j , i ) = [ {T}_{0}^{( j , i )} - ( {T}_{B} ) mod ( L ) ] mod ( L ) ,$$

where L=T_{AC} (i.e., the AC cycle duration) or T_{AC}/2, T_{B} is the time duration of the beacon interval, and mod(·) is the modulo operator. Accordingly, node 1 develops a set of Tone Maps with index TMI(j,i) and associated Time Offsets T₀^{(j,i)}. The Tone Map with index TMI(j,i) may contain ideal FEC and modulation formats for transmitting packets at ideal time instants:

t_{ideal}^{(j)}(k)=T₀^{(j,i)}+k·L, where k=1, 2, . . . , K

so that t_{ideal}^{j}(K) is contained within the j^{th} beacon interval.

Lastly, consider DC-based power line networks. For DC networks, such as may be used in a car, an airplane, space stations, etc., the channel does not usually undergo periodic channel variations so that time offset and packet duration information are not as useful. In this case, the duration of the beacon interval could be irrelevant as far as channel estimation is concerned. In these environments, impedance mismatches are the typical source of channel variations and these tend to occur randomly, possibly together with sudden changes in topology. In this case, the transmitter updates its tone map upon receiving the ACK packet containing a partial tone map and applies the updated tone map to the next packet in the queue.

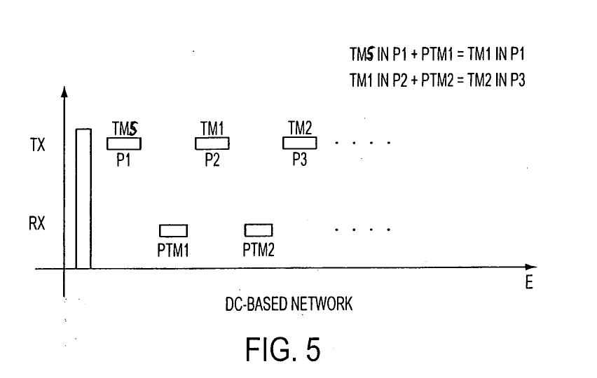

FIG. 5 illustrates packet communication between two nodes in a DC network. In this harsh environment, channel estimation needs to be much more robust than in the AC case, so the use of pilot carriers is advisable. Since transmission schemes are corrected at every packet transmission, the proposed technique of exploiting the ACK packets to provide a feedback channel is very useful. Note that a trade off between accuracy and frequency of channel estimation and Media Access Control (MAC) efficiency must also be made.

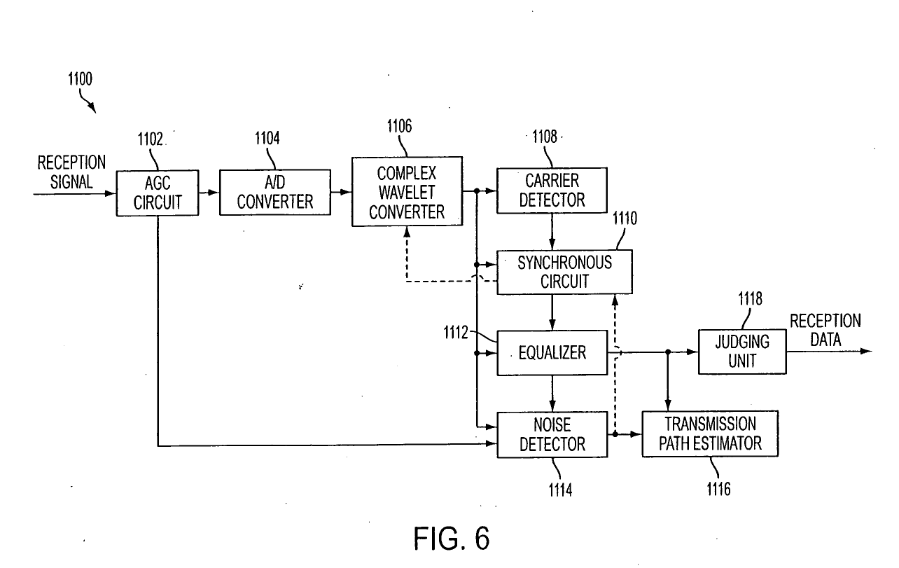

FIG. 6 illustrates a receiving section of a network node. The receiving section 1100 includes an Automatic Gain Circuit (AGC) 1102 that automatically adjusts the gain applied to a received analog signal and an Analog-to-Digital (A/D) converter 1104 that converts the gain adjusted analog signal into a digital signal. A complex wavelet converter 1106 generates an in-phase signal and an orthogonal signal by wavelet-converting the digital signal. A carrier detector 1108 detects a carrier signal within the wavelet-converted signal. A synchronous circuit 1110 synchronizes the receiver to the received signal. An equalizer 1112 compensates the received signal for distortions caused by the transmission path. A noise detector 1114 detects the presence or absence of narrow-band noise in each sub carrier band, by use of a signal after complex wavelet conversion. A transmission path estimator 1116 determines primary modulation, which is used in each sub carrier of a symbol mapper in a transmitting device, by use of a signal output from equalizer 1112 and information of the presence or absence of narrow-band noise output from noise detector 1114. A judging unit 1118 generates the received data by use of a signal output from equalizer 1112.

Although FIG. 6 shows a particular multi-carrier system that uses wavelet conversion, other kinds of multi-carrier systems may be used, whether they use wavelet conversion or not. For example, it can be used in conventional Orthogonal Frequency Division Multiplexing (OFDM), windowed OFDM, and even Discrete Multi-Tone (DMT) systems.

Most multi-carrier systems have a transmission path estimator 1116 that determines the modulation used in each sub carrier. A tone map TM, as used herein, may designate a set of modulations and corresponding sub-carriers.

Generally, in case of carrying out transmission path estimation, a frame that is known both by the transmitter and the receiver is transmitted from the transmitting device for the purpose of transmission path estimation. In transmission path estimator 1116 of the receiving device, the Carrier Power-to-Interference-Plus-Noise Power Ratio (CINR) is measured for every sub-carrier. By use of the CINRs measured in each sub carrier, the TM, i.e., the primary modulation (e.g., 16PAM, 8PAM etc.) to be used in each sub carrier, is selected on the basis of a set of CINR thresholds.

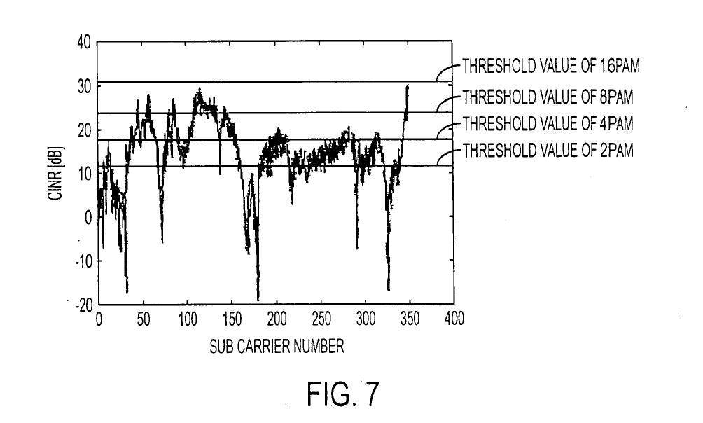

FIG. 7 illustrates an example of how the TMs may be selected on the basis of a set of CINR thresholds. It is possible to have multiple thresholds depending on the FEC that the system uses. As multiple FECs may be available, the system may decide, on the basis of a certain metric, what combination of TM and FEC is better to use, for example, the combination that ensures the highest throughput could be used.

The particular method used for TM creation at a receiver does not limit the invention. The invention has general applicability and can be applied independently of the particular method used for TM creation.

In related art systems, a receiver informs a transmitter of a chosen TM: a) using a special response frame; b) only after transmission path estimation has been invoked and a well-known frame has been transmitted by the transmitter; and c) by transmitting the entire TM from the receiver to the transmitter.

In the present invention, the receiver may choose to transmit back to the transmitter only a sub-set of the TM, and it would do so not necessarily by invoking a transmission path estimation using a specially dedicated frame but it may do so by exploiting the ACK packets sent back to the transmitter after every frame is received by the receiver.

In general, the ACK packet is used as a response from the receiver to the transmitter to indicate the reception of a data packet. Corresponding to the reception status of a data packet, the ACK packet can either inform the source station of a normal reception or make a retransmission request. In order to keep overall system efficiency high, ACK packets are often very small.

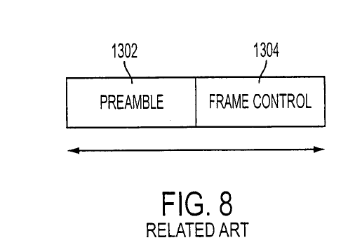

FIG. 8 illustrates an example of a related art ACK packet. Acknowledgment packet 1300 includes a preamble 1302 component and a frame control component 1304.

The present invention may take advantage of acknowledgment packets to provide a feedback channel to the transmitter, in the context of transmission path estimation. In particular, the receiver may create a TM on the basis of a received packet and send the TM back in full or in part to the transmitter so that improved modulation schemes can be used by the transmitter on a per packet basis. Therefore, the acknowledgment packet of the present invention may be augmented with a variable length field containing either a full or partial TM.

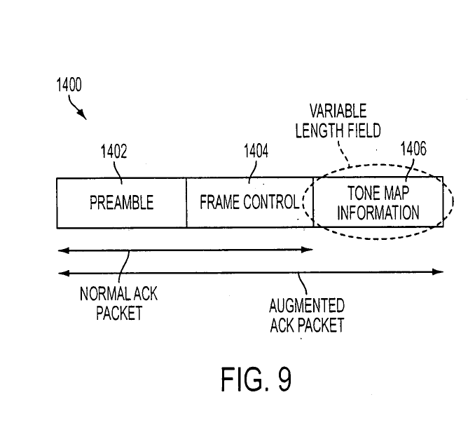

FIG. 9 illustrates an acknowledgment packet augmented with a variable length field. Acknowledgment packet 1400 includes a preamble component 1402, a frame control component 1404, and a tone map information component 1406. Tone map information component 1406 is preferably of variable length so that the receiver may decide on a case-by-case basis how much TM information to send back to the transmitter.

Many implementations of the invention are possible. For example, a receiver may calculate a preferred tone map by decoding an entire packet or by using only the header of the packet (e.g., preamble, control signals, etc.). The receiver may detect whether a packet is decoded without errors, and in such case, it may use all the symbols in the packet, including the payload, to compute an average tone map TM. Here, average is meant in the sense of averaging SNR over the duration of the packet, which may be preferred since noise may be averaged out. Once the tone map is calculated, it can be entirely or partially fed back to the transmitter using either ACK packet 1400 or a small data packet.

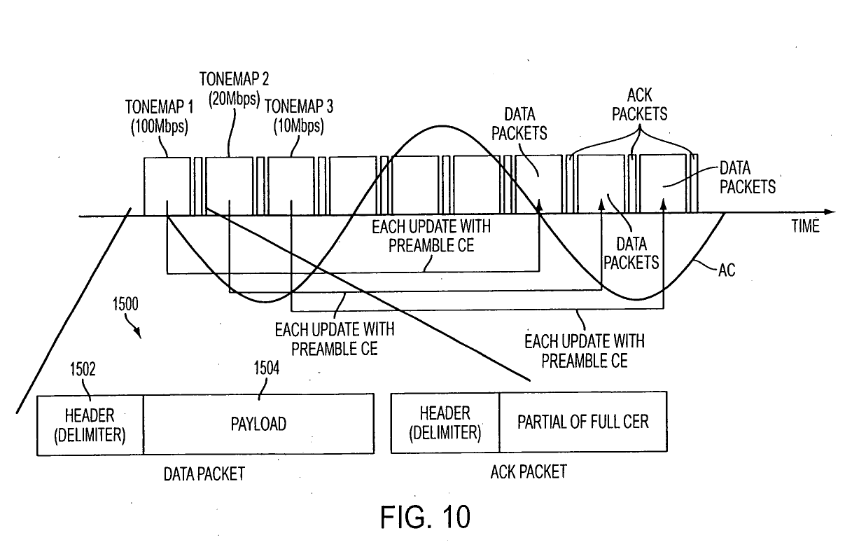

FIG. 10 illustrates a packet structure for communicating tone map information. Data packet 1500 includes a header component 1502 and a payload component 1504.

If the receiver does not use the payload data for tone map calculation, then it may use the header or the frame control information of the header, which may be transmitted using robust modulations. For example, a Cyclic Redundancy Code (CRC) component of the header may be checked to detect if errors have been made.

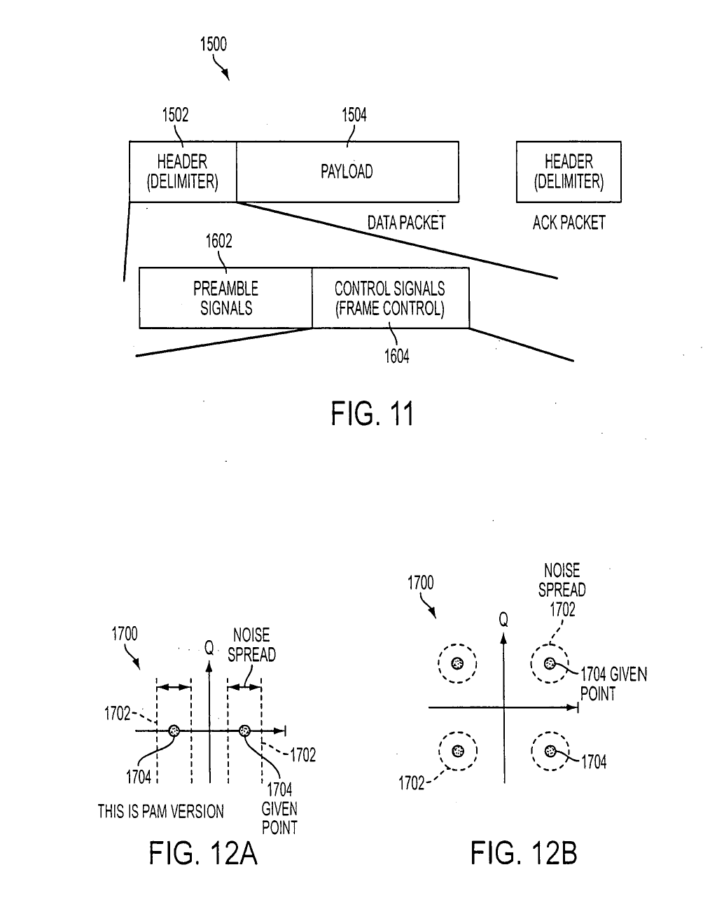

FIG. 11 illustrates components of a data packet's header. Header 1502 includes a preamble signals component 1602 and a frame control component 1604.

Transmitting a partial tone map represents a compromise between the accuracy of channel estimation and efficiency of the system. To limit overhead, it is desirable to use partial tone maps. The SNR may be calculated on a per sub-carrier basis, by calculating the mean square of the difference between a received data point and the reference point of the constellation.

FIGS. 12A and 12B illustrate noise spread of a received signal with respect to reference points of a modulation constellation. As illustrated in FIGS. 12A and 12B, a received signal produces noise spread 1702 about each reference point 1704 of modulation constellations 1700.

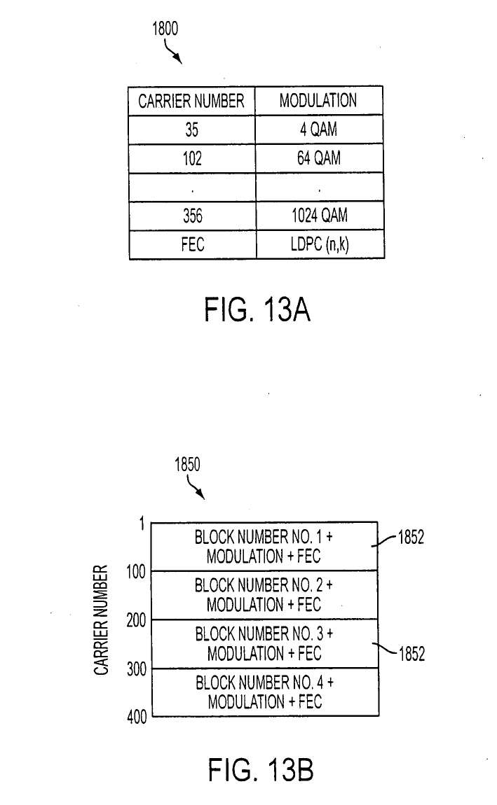

FIGS. 13A and 13B illustrate partial Channel Estimate (CE) maps. FIG. 13A illustrates a partial CE map 1800 used by a receiver to feedback only the number of carriers, C, that exhibit the largest SNR difference between the tone map used by the transmitter and a preferred tone map calculated by the receiver, where C may be 10, 30, or 50, for example. FIG. 13B illustrates a partial CE map 1850 that divides the carriers into blocks 1852; in this instance, the receiver might feed back only the most deteriorated block or blocks 1852. This feature is especially useful for an indoor environment, which is characterized in the frequency domain by correlated changes in the transmission path, i.e., often blocks of frequency change together rather than changes being randomly spread across the bandwidth. Partial maps 1800 and 1850 may be contained in the variable length part 1406 of the augmented ACK packet 1400 illustrated in FIG. 9.

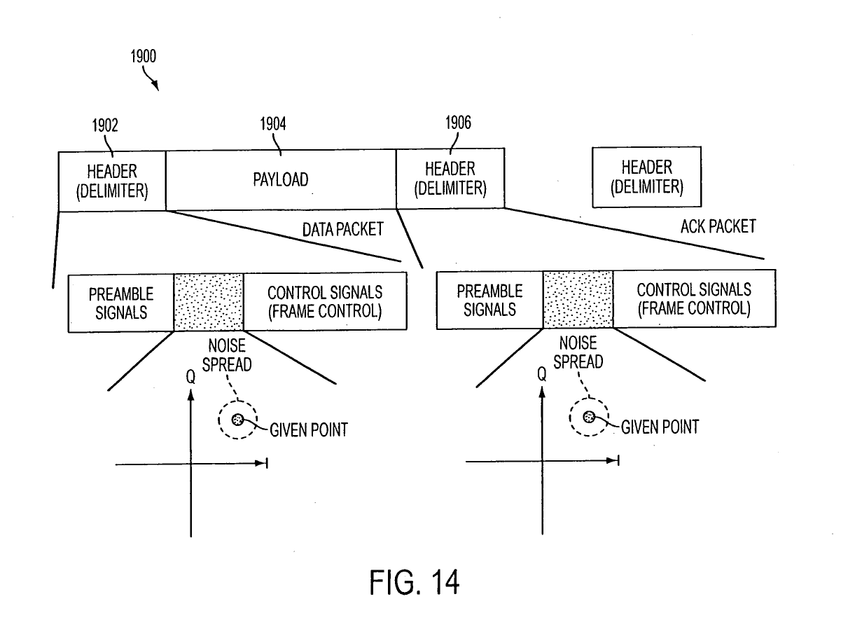

In another implementation, a postamble can be added to the data packet. FIG. 14 illustrates a data packet having a postamble. Data packet 1900 includes a preamble header 1902, payload 1904, and a postamble header 1906. Postamble 1906 is a sequence of symbols known at the receiver that is added after payload 1904 and at the end of data packet 1900. The known symbols can be a simple repetition of preamble symbols or an ad-hoc training sequence. Although more overhead is introduced than in the previous case, this implementation ensures more accuracy in the estimation of the SNR per sub-carrier. In fact, a postamble is temporally closer to the next transmitted packet, so that the tone map computed using the postamble is generally better than the one computed using the preamble.

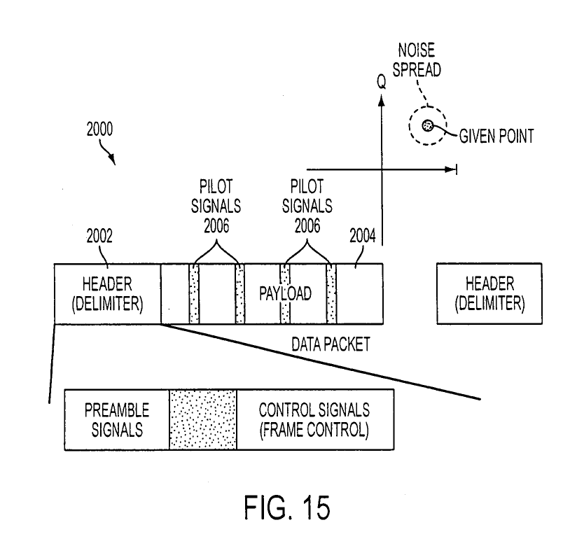

An alternative implementation uses pilot signals spaced across the data packet. FIG. 15 illustrates a data packet having pilot signals spaced across its length. Data packet 2000 has a header component 2002 and a payload component 2004. Multiple pilot signals 2006 are spaced at intervals within payload component 2004. In this case, the channel is “sampled” at regular intervals and abrupt channel variations along the packet can be detected. Additionally, the use of pilot signals is particularly effective on vehicular networks as channel variations may be random and abrupt.

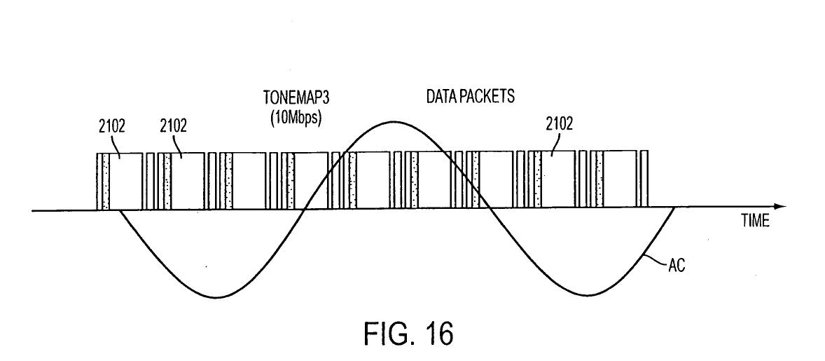

If the beacon interval Tb is a multiple of the AC cycle, then the receiver can compute the per-carrier-SNR using a moving average that goes beyond a packet and even beyond a beacon interval. FIG. 16 illustrates computing a moving average of sub-carrier SNR for a packet stream. A moving average of the SNR may be useful because each data packet 2102 may have only a few signals by which the SNR may be calculated.

Alternatively, if the beacon interval is not a multiple of the AC cycle, the moving average (i.e., smoothing) may be re-initialized at every beacon. The smoothing effect of the moving average provides a better estimate of the SNR because more samples are involved in the estimation. Also, such smoothing provides better detection when major changes occur in the channel state.

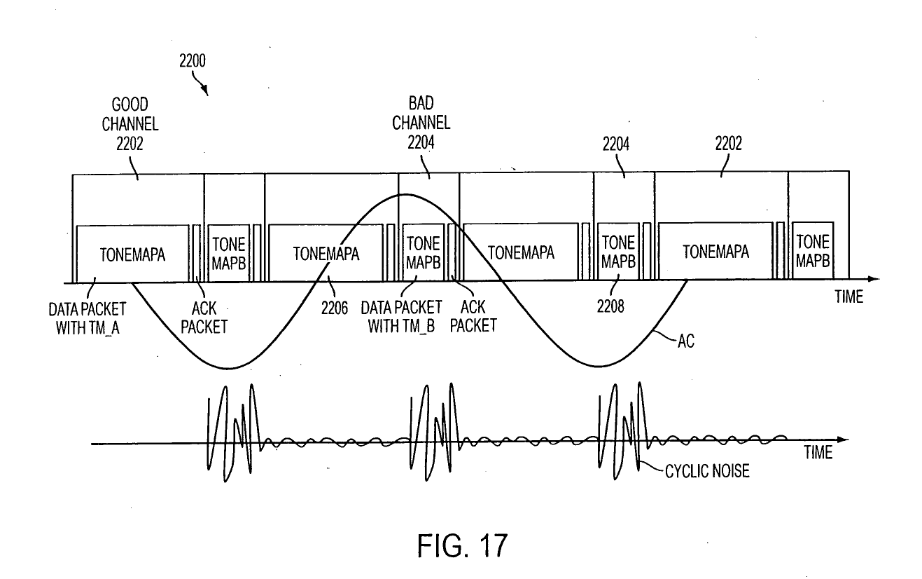

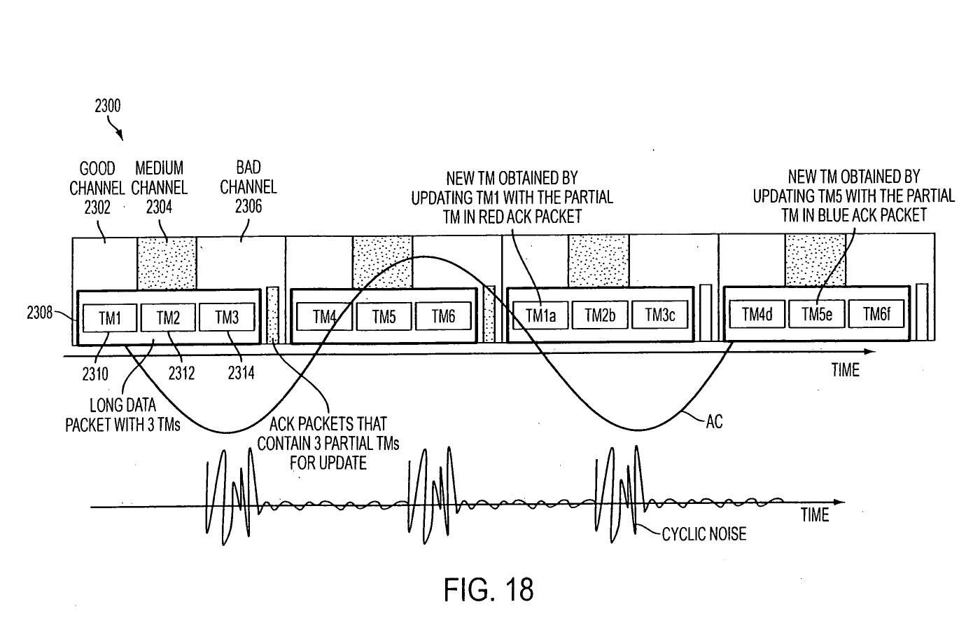

FIG. 17 illustrates applying packets of varying lengths to a communication channel having a time-varying characteristic. Communication channel 2200 has time-varying instances of good quality 2202 and poor quality 2204. Thus, different-length data packets may be applied to the channel in accordance with the respective length of good and poor quality. In FIG. 17, the channel quality is good most of the time; thus, long data packets 2206 are used during the periods of good channel quality and shorter data packets 2208 are used during the relatively short periods of poor channel quality. The use of short packets tends to reduce the MAC efficiency and overall throughput, though.

However, MAC efficiency and throughput can be improved by using multiple tone maps TMs within the same packet. FIG. 18 illustrates applying multiple tone maps to the transmission of a data packet in a channel having a time-varying characteristic. Communication channel 2300 has periods of good channel quality 2302, medium channel quality 2304, and poor channel quality 2306. A different tone map may be applied to each channel period. Thus, a first tone map 2310 is applied to the transmission of a data packet 2308 during the period of good channel quality 2302, a second tone map 2312 is applied during the period of medium channel quality 2304, and a third tone map 2314 is applied during the period of poor channel quality. Moreover, each tone map 2310-2314 may handle different size portions of data packet 2308. Applying multiple tone maps to a single data packet supports the ability to use long data packets in a channel of time-varying quality without sacrificing reception quality and MAC efficiency. And since MAC efficiency is improved, slightly longer ACK packets may be used without significantly affecting throughput. This is useful since the ACK packets must contain the update of multiple tone maps. Even with longer ACK packets, overall MAC efficiency is still improved. However, computational cost is higher since multiple tone maps have to be computed and allocated within the same data frame.

If the channel is in a steady state and it is no longer necessary for the receiver to feed back partial tone maps to the transmitter, then the receiver can instruct the transmitter to increase its frame duration to increase overall MAC throughput. It is clear that, if the frame duration is changed, then it is likely that new partial tone maps will be generated by the receiver to adapt for the use of longer packets. However, if the channel is in a steady state, then the receiver will progressively update the transmitter tone map until a new and stable advantageous scheme is reached. Again, if the conditions allow it, the receiver can again instruct the transmitter to increase frame duration.

The receiver can also detect whether the noise has increased (or decreased) between the start and the end of the packet. This can be accomplished by checking the corrected errors in every ethernet frame contained in the packet. If the number of corrected errors in every frame increases (decreases) with time, then noise is also increasing (decreasing). For example, in AC-based PLC networks, noise may increase as the main voltage increases towards its peak value (±110, or ±240); vice versa, noise may decrease as the main voltage decreases towards zero. If the receiver detects that any of those situations are occurring, then it could anticipate the evolution of noise with time and apply a weaker (or stronger) FEC, or compute tone maps weighing more the symbols in the preamble or in the postamble.

If node I transmits to node j, then every other node in the same home network will receive the data packet sent by node I and the successive ACK packets sent by j. Therefore, every node k in the network will be able to calculate a tone map for improved transmission from k to I and from k to j. Since the above consideration holds for every node k in the home network, this is helpful as every node in the network may determine the best tone map for communicating with any other node. Therefore, when a node needs to send data to another node and it has a recent tone map for transmitting to that node, it can utilize such tone map to increase its data rate with respect to the case when a low rate robust packet must be sent or when an RCE/CER sequence must be invoked to estimate the channel.

The exploitation of ACK packets for dynamic channel estimation also allows nodes to always have a recent estimate of the channel that can be used to transmit information exploiting efficient transmission schemes without the necessity of invoking an RCE/CER procedure. In fact, the power line channel is a broadcast medium similar to wireless, and any node is able to receive data or ACK packets transmitted by any other node.

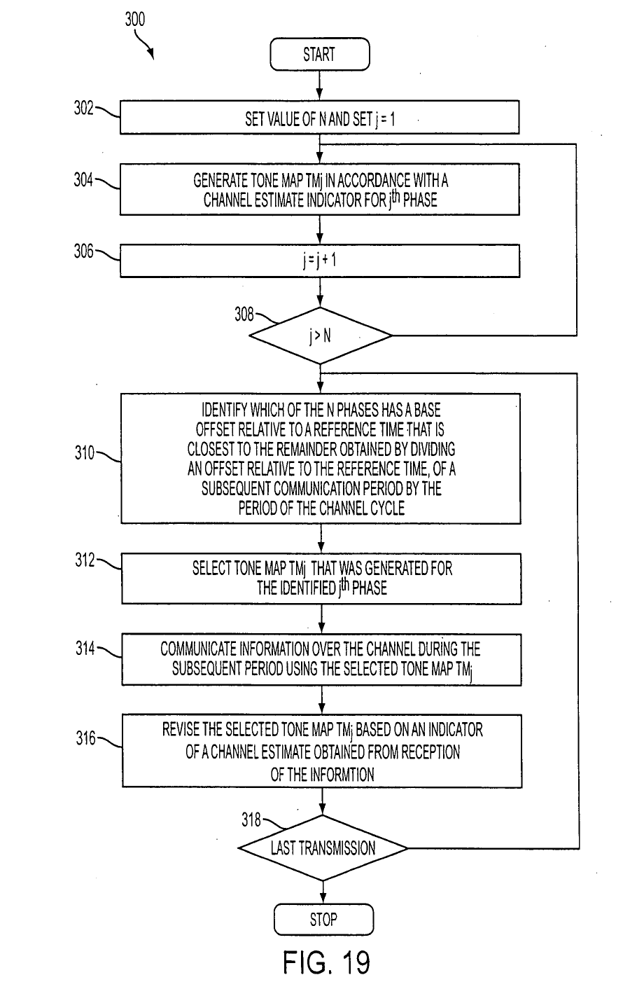

FIG. 19 illustrates a method of applying a tone map to a communication channel having a cyclically time-varying characteristic, such as cyclically varying noise in an AC cycle period. According to method 300, a first node, node 1, communicates information to a second node, node 2, using a tone map. Node 2 acknowledges receipt of each unit of information in an ACK message that includes information (e.g., a partial tone map) for updating the applied tone map. The method of FIG. 19 associates every tone map to a particular phase region within a beacon period, rather than with particular start times and durations of particular packet transmissions as in above embodiments.

More specifically, node 1 initializes at 302 a parameter N to have an integer value equal to the number of phases into which a cycle of channel characteristic variation will be divided and initializes a counter j to have a value of 1. Node 1 generates at 304 a tone map TMⱼ in accordance with a channel estimate indicator for the phase, received from node 2 in an ACK message, and increments at 306 the value of counter j by one. Node 1 repeats at 308 operations 304 and 306 for each phase of the subdivided cycle. Node 1 identifies at 310 which of the N phases has a base offset relative to a reference time (e.g., the beacon) that is closest to the remainder produced by dividing (a) an offset, relative to the reference time, of a subsequent communication by (b) the period of the channel cycle. Node 1 selects at 312 the tone map that was generated for the identified phase and communicates at 314 information over the channel to node 2 during the subsequent period using the selected tone map. Node 1 revises at 316 the selected tone map based on an indicator of a channel estimate obtained from reception of the information by node 2 and communicated to node 1 in an ACK message. Node 1 repeats at 318 operations 310-316 until no information remains to be transmitted to node 2. In the above-described method, the base offset of each of the N phases is equivalent to the remainder produced by dividing the phase's offset by the cycle period of the channel characteristic variation.

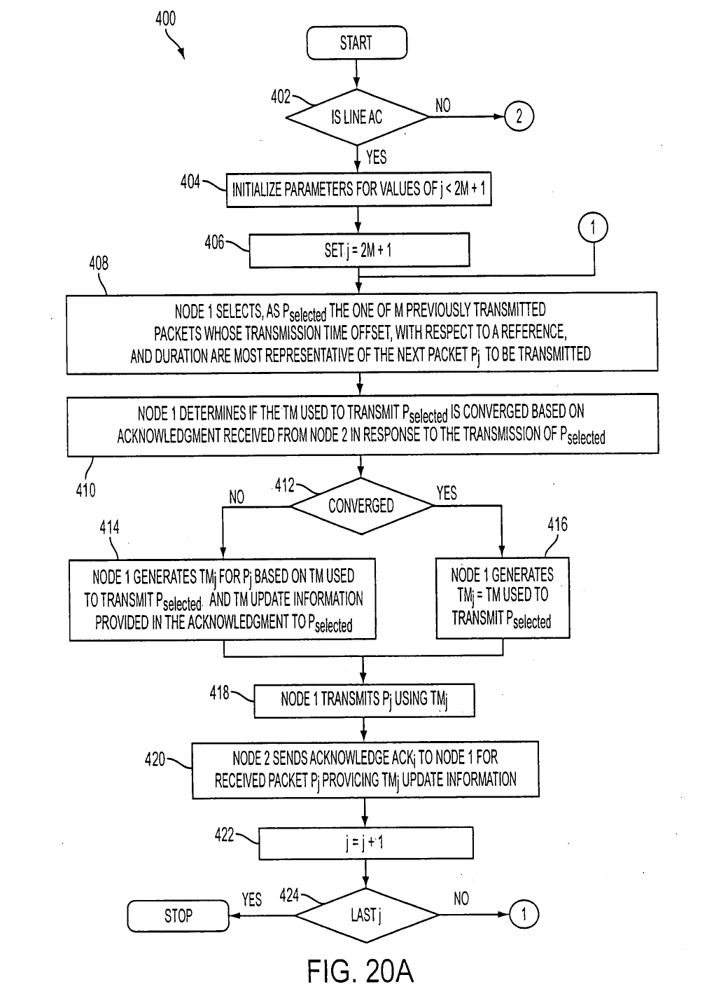

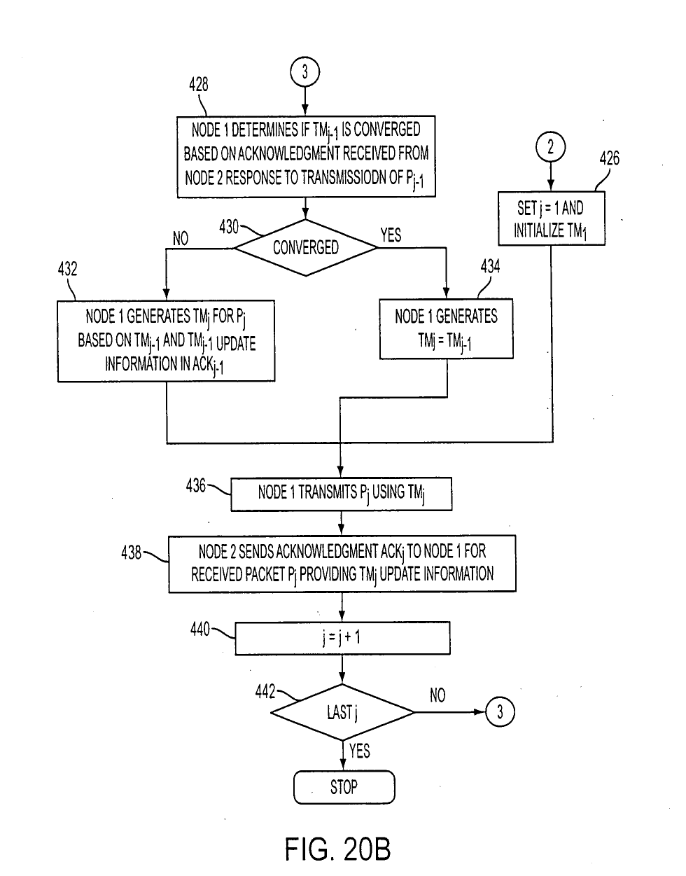

FIGS. 20A and 20B illustrate a method flow chart of another embodiment of the invention in which two network nodes, node 1 and node 2, are communicating. According to method 400, node 1 determines at 402 if the communication channel with node 2 has an applied AC component. If so, node 1 initializes at 404 a tone map, a transmission offset, and transmission duration information for each of the first M representative packets that it transmits. Specific examples of how the information for the representative packets is initialized are described in subsequent embodiments of the invention. The representative packets are those having transmission offsets and transmission durations, in association with the tone maps generated for these packets, that adequately represent the different conditions of interference experienced by packets communicated on the AC communication channel.

Although FIG. 20A illustrates initializing a constant value of M representative packets before proceeding to operation 408, the value of M may be progressively increased while performing method 400; for example, a determination could be made between operations 422 and 424 whether to increase the value of M, and if so, the method could initialize the parameters for the additional packets and progress to operation 424.

After the information relating to the M representative packets is initialized at 404, node 1 sets at 406 a counter j to a value of j=2M+1. Node 1 selects at 408, as P_{selected}, the one of M previously transmitted packets whose transmission time offset, with respect to a reference, and duration are most representative of the next packet Pⱼ to be transmitted.

If the packet duration of next packet Pⱼ is expected to be long with respect to the cycle period of the AC component on the communication channel, then multiple representative packets may be selected to represent the anticipated channel conditions during the transmission of next packet Pⱼ, with each representative packet having a different associated offset and possibly a different packet duration. Thus, next packet Pⱼ may be subdivided into sub-packets such that one or groups of the sub-packets are transmitted in accordance with information relating to the most representative selected packet. Stated another way, the tone map for each of the multiple selected representative packets may be applied to one or more groups of the sub-packets when they are transmitted.

The determination of which of the M representative packets is most representative of the next packet to be transmitted may be made in many ways. For example, node 1 may divide a representative packet's transmission offset from a reference time, as may be indicated by a beacon transmission, by the cycle period of the AC channel component and use the remainder of this division as the packet's base offset. Node 1 may similarly divide the transmission time offset of the next packet to be transmitted to determine its base offset and compare this base offset to the base offsets of the representative packets. The representative packet having the closest base offset to that of the next packet to be transmitted is selected as the most representative packet. Other considerations may be evaluated, also, to determine the most representative packet, such as packet duration.

Upon selecting at 408 the most representative packet, node 1 retrieves the tone map associated with this packet and determines at 410, 412 if this tone map has adequately converged, such that further refinement of the tone map is unnecessary. Determination 410, 412 may be made based upon tone map update information communicated by node 2 in a message acknowledging receipt of the previously transmitted representative packet. Although FIG. 20A illustrates determination 410, 412 being made after a representative packet is selected, this determination may be similarly made at some other time, such as when the acknowledgment to the representative packet is received so that the tone map information for the representative packet may be updated at 414, 416 at this time.

After the convergence determination 410, 412 is made, node 1 generates at 414, 416 tone map TMⱼ for the next packet Pⱼ to be transmitted. When convergence is not found, TMⱼ is generated at 414 based upon the tone map, if any, used to transmit the selected representative packet and the information provided in the acknowledgment to the representative packet for updating the applied tone map or creating a tone map. When convergence is found, node 1 applies at 416 the tone map used to transmit the selected representative packet as TMⱼ and may adjust the coding and modulation rate for transmitting Pⱼ so as to better utilize the communication channel.

After generating at 414, 416 TMⱼ, node 1 transmits at 418 packet Pⱼ using the generated tone map TMⱼ. In response to receiving packet Pⱼ, node 2 sends at 420 an acknowledgment message ACKⱼ to node 1 providing update information that may be used to update the tone map for the selected representative packet. Thus, the tone map for the selected representative packet may be revised after each use.

Node 1 increments at 422 packet counter j by a value of one after the transmission of packet Pⱼ and determines at 424 whether more packets will be transmitted. If so, method 400 repeats at 424 the execution of operations 408-422; otherwise, execution ceases.

If node 1 determines at 402 that no significant AC component exists on the communication channel, then node 1 sets at 426 counter j to a value of one and initializes at 426 a tone map TM₁, if one exists, for the first transmitted packet P₁. Node 1 transmits at 436 packet Pⱼ to node 2 using TMⱼ, if it exists. In response to receiving packet Pⱼ, node 2 sends at 438 an acknowledgment ACKⱼ to node 1 providing information for updating or creating TMⱼ.

Node 1 increments at 440 packet counter j by a value of one after the transmission of packet Pⱼ and determines at 442 whether more packets will be transmitted. If not, method 400 ceases execution.

Otherwise, node 1 determines at 428, 430 whether tone map TMⱼ₋₁ is converged based upon the information provided in ACKⱼ₋ᵢ. If so, node 1 applies at 434 tone map TMⱼ₋₁ as tone map TMⱼ; if not node 1 generates at 432 tone map TMⱼ from tone map TMⱼ₋₁ and the update information provided in ACKⱼ₋₁. Then, node 1 re-executes operations 436-442.

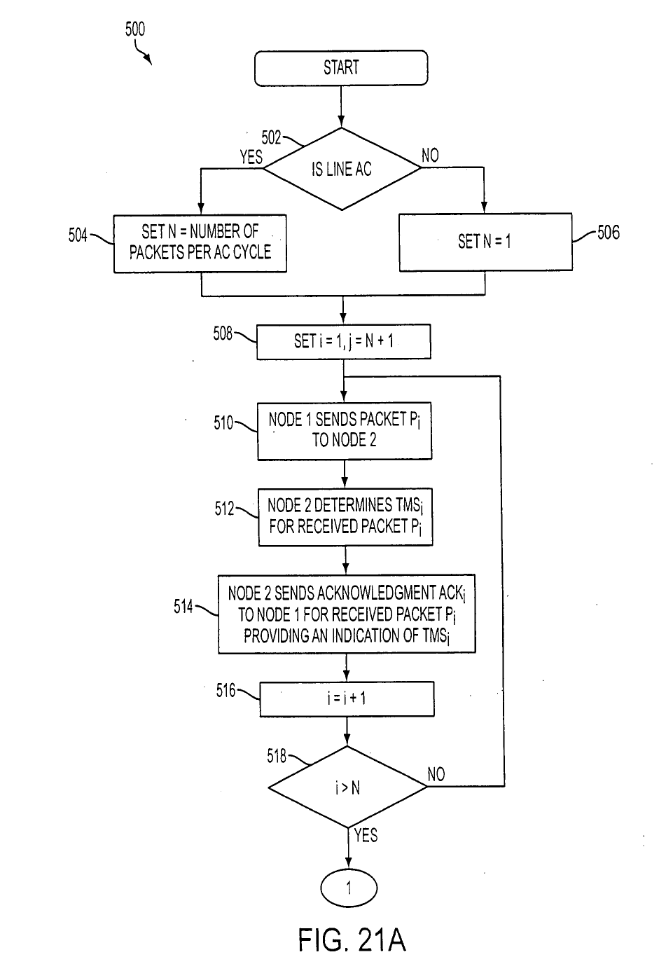

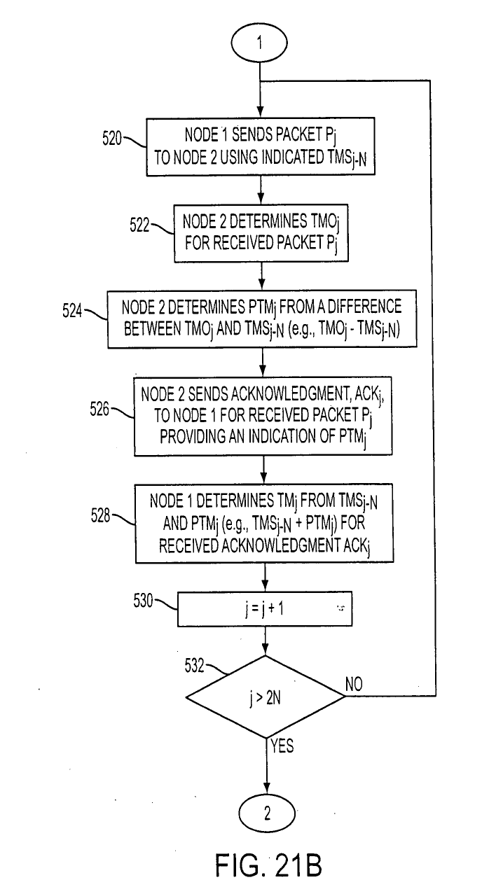

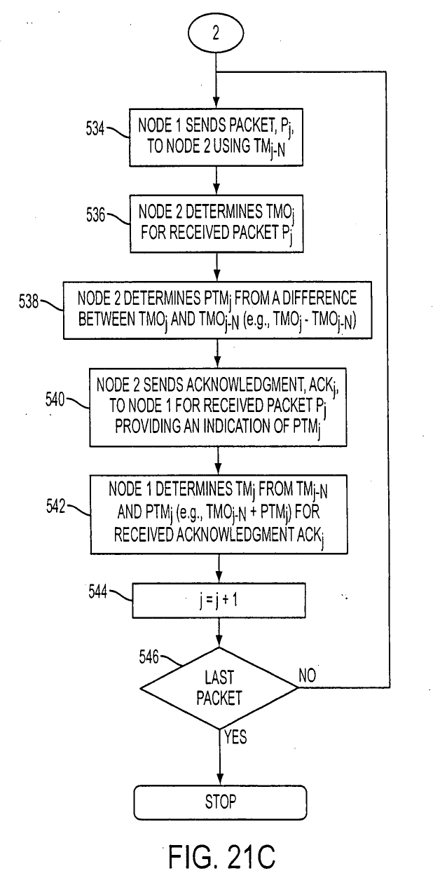

FIGS. 21A-21C illustrate a method flow chart of another embodiment of the invention. Method 500 is highly appropriate for network communication in which the transmission of packets occurs with the same periodicity in each cycle of an AC signal existing in the communication channel. Method 500 also provides a more detailed explanation of how an initial tone map is generated for either an AC or a DC communication channel.

According to method 500, a first node, node 1, determines at 502 whether a significant AC signal component exists in the communication channel. If so, node 1 sets at 504 a parameter N equal to the number of packets transmitted by node 1 in each AC cycle; otherwise, node 1 sets at 506 N equal to one. In either case, node 1 also sets at 508 a counter i equal to one and a counter j equal to N+1.

Node 1 transmits at 510 a packet Pᵢ to node 2 through the communication channel. Node 2 determines at 512 a Tone Map Start (TMS) TMSᵢ for packet Pᵢ based upon its reception characteristic and communicates at 514 an indication of TMSᵢ to node 1 in a message ACKᵢ acknowledging receipt of packet Pᵢ. The tone map start TMS may be a packet carrying data (e.g., data unknown to the receiver) that is robustly modulated or a packet carrying a special training sequence that is known to the receiver so as to improve the accuracy of the channel estimation.

Thereafter, node 1 increments at 516 the value of counter i by one and determines at 518 whether the incremented value exceeds the value of N. If not, node 1 re-executes at 518 operations 510-516 until node 1 receives a tone map start TMS for each packet transmitted within an AC cycle. The tone map start TMS may be a packet carrying data (e.g., data unknown to the receiver) that is robustly modulated or a packet carrying a special training sequence that is known to the receiver so as to improve the accuracy of the channel estimation.

Once node 1 receives the indication for each of TMS₁, . . . , TMS_{N} and counter j is incremented to a value of N+1, node 1 transmits at 520 a packet Pⱼ to node 2 using TMS_{j-N}. Node 2 determines at 522 a revised tone map (e.g., more optimal Tone Map (TMO)) TMOⱼ for packet Pⱼ based upon its reception characteristic. To reduce the amount of information required to communicate TMOⱼ, node 2 may generate at 524 a Partial Tone Map (PTM) PTMⱼ that represents the information of TMOⱼ. For example, PTMⱼ may express some or all of the differences between TMS_{j-N} and TMOⱼ. In either case, node 2 communicates at 526 an indication of TMOⱼ to node 1 in a message ACKⱼ acknowledging receipt of packet Pⱼ. FIG. 21B illustrates that an indication of PTMⱼ is communicated at 526 in ACKⱼ as a substitute for the indication of TMOⱼ.

Upon receiving ACKⱼ, node 1 determines at 528 an appropriate tone map TMⱼ for Pⱼ based upon the tone map TMS_{j-N} used to transmit Pⱼ and the indication of TMOⱼ provided in ACKⱼ. In the specific example illustrated in FIG. 21B, node 1 reconstructs the information of TMOⱼ by combining the information of TMS_{j-N} with that of PTMⱼ, as indicated in ACKⱼ, and assigns this reconstructed information to tone map TMⱼ.

Node 1 increments at 530 the value of counter j by one and repeats at 532 operations 520-530 until each of the N packets transmitted in a second AC cycle of the communication channel has an associated tone map TM. These associated tone maps TM_{N+1}, . . . , T_{M+N} are revised tone maps of the corresponding tone map starts TMS₁, . . . , TMS_{N} used to transmit packets P_{N+1}, . . . , P_{N+N}. If the communication channel does not have a significant AC component, then the sole tone map TM₂ generated by operations 520-532 represents an update of the start tone map TMS₁ used to transmit packet P₂.

After a tone map TM has been generated for each of N packets in operations 520-532 and counter j has been incremented to a value of 2N+1, node 1 transmits 534 a packet Pⱼ to node 2 using TM_{j-N}. Similar to operations 522-526, node 2 determines at 536 a revised tone map TMOⱼ for packet Pⱼ based upon its reception characteristic, generates at 538 a partial tone map PTMⱼ that represents the information of TMOⱼ and communicates at 540 an indication of PTMⱼ to node 1 in a message ACKⱼ acknowledging receipt of packet Pⱼ.

Upon receiving ACKⱼ, node 1 determines at 542 an appropriate tone map TMⱼ for Pⱼ based upon the tone map TM_{j-N} used to transmit Pⱼ and the indication of PTMⱼ provided in ACKⱼ. In the specific example illustrated in FIG. 5C, node 1 reconstructs the information of TMOⱼ by combining the information of TMS_{j-N} with that of PTMⱼ, as indicated in ACKⱼ, and assigns this reconstructed information to tone map TMⱼ. Node 1 increments at 544 the value of counter j by one and repeats 546 operations 534-544 until no further packets remain to be transmitted.

To better understand method 500, Table 2 tabulates a specific example of how the tone maps are generated and applied to the first twelve packets transmitted from node 1 to node 2 when N=3.

TABLE 2
Example of Three Periodic Packet Transmissions per AC Cycle

| Packet | | Acknowledgment | Information in |
|---|---|---|---|
| Number | Applied Tone Map | Number | Acknowledgment |
| P₁ | | ACK₁ | TMS₁ indicator |
| P₂ | | ACK₂ | TMS₂ indicator |
| P₃ | | ACK₃ | TMS₃ indicator |
| P₄ | TMS₁ | ACK₄ | PTM₄ indicator |
| P₅ | TMS₂ | ACK₅ | PTM₅ indicator |
| P₆ | TMS₃ | ACK₆ | PTM₆ indicator |
| P₇ | TM₄ = TMS₁ + PTM₄ | ACK₇ | PTM₇ indicator |
| P₈ | TM₅ = TMS₂ + PTM₅ | ACK₈ | PTM₈ indicator |
| P₉ | TM₆ = TMS₃ + PTM₆ | ACK₉ | PTM₉ indicator |
| P₁₀ | TM₇ = TM₄ + PTM₇ | ACK₁₀ | PTM₁₀ indicator |
| P₁₁ | TM₈ = TM₅ + PTM₈ | ACK₁₁ | PTM₁₁ indicator |
| P₁₂ | TM₉ = TM₆ + PTM₉ | ACK₁₂ | PTM₁₂ indicator |

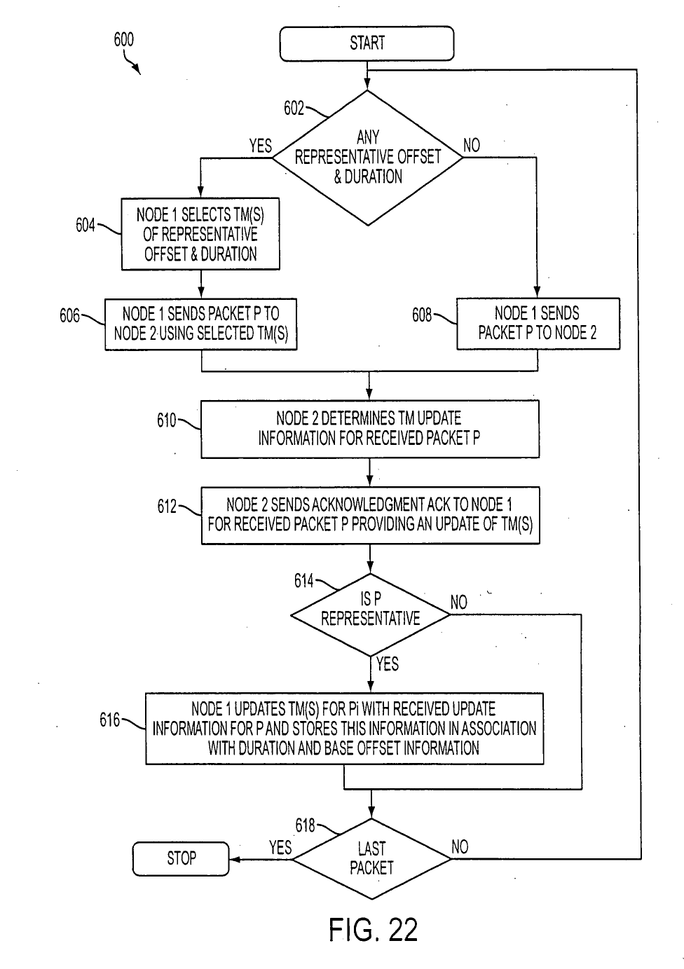

FIG. 22 illustrates a method flow chart of another embodiment of the invention. Method 600 is highly appropriate for network communication in which: (1) the transmission of packets is not necessarily periodic and (2) the transmission duration of packets is long with respect to the cycle of an AC component existing in the communication channel.

According to method 600, a first node, node 1, determines at 602 whether any previously transmitted packets, which have been recorded, had transmission durations or transmission offsets, with respect to a reference time, that are representative of the duration and offset for a packet to be transmitted next. If so, node 1 selects at 604 the tone map TM associated with the representative packet and transmits at 606 the next packet P using the selected tone map TM. In a case where the packet duration is long with respect to a cycle of an AC component existing in the communication channel, multiple tone maps TMs may be associated with the representative packet so that the packet to be transmitted next may be subdivided and transmitted with each of the TMs applied to a subdivision of the packet. If no representative packets exist, node 1 transmits at 608 packet P to node 2.

Upon receiving packet P, node 2 determines at 610 update information for the tone map(s) TM(s) applied to packet P or creates at 610 one or more tone maps TMs for the packet if none was applied. Node 2 communicates at 612 to node 1 an indication of the update information or created tone map(s) in a message, ACK, acknowledging receipt of packet P.

Node 1 determines at 614 whether the transmission duration, offset information, and updated tone map information for packet P would better represent the conditions expected for the transmission of subsequent packets than such information for any existing representative packets. If so, node 1 records at 616 the duration, offset, and updated or created tone map information for packet P; otherwise, node 1 discards this information. Thereafter, operations 602-616 are repeated at 618 until no further packets remain to be transmitted.

As described above, method 600 improves the tone maps used to transmit a sequence of packets by updating, for each transmitted packet, the tone map(s) applied to a previously transmitted packet that had similar transmission duration and time offset characteristics.

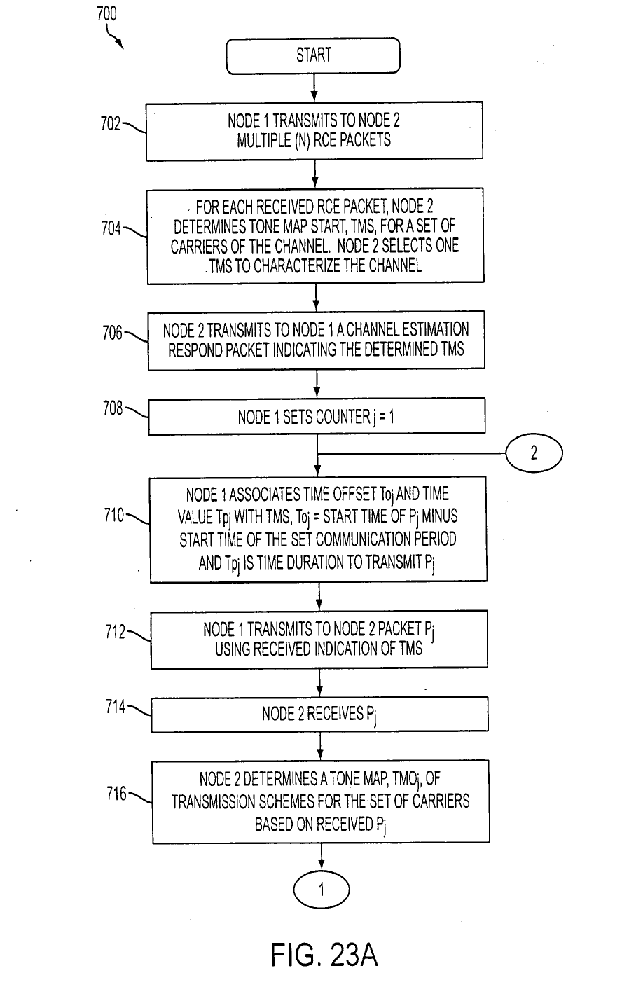

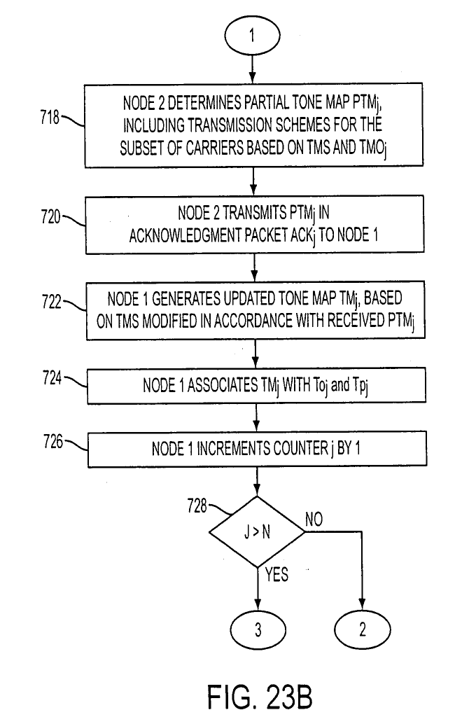

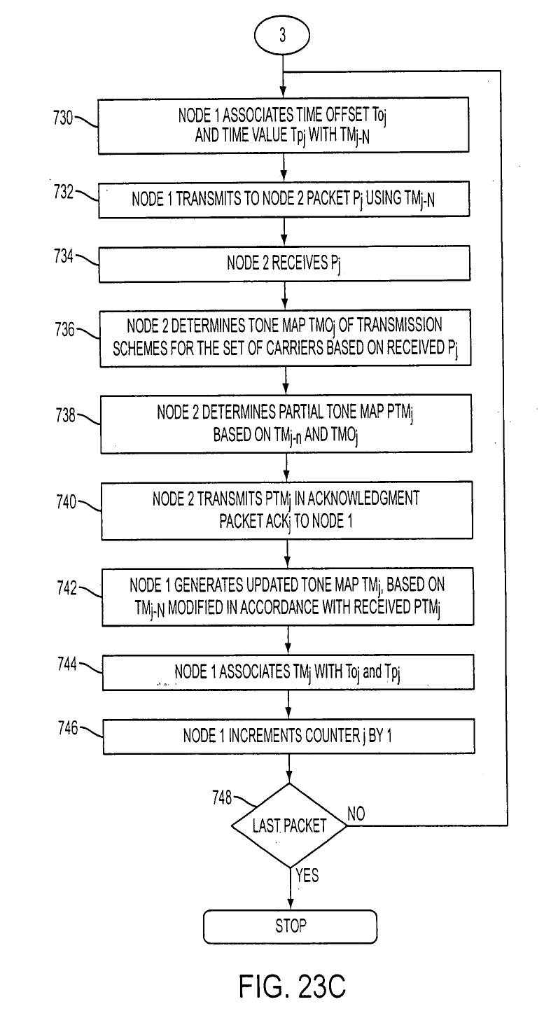

FIGS. 23A-23C illustrate a method flow chart of another embodiment of the invention. According to method 700, node 1 initiates channel estimation by sending at 702 N Request for Channel Estimation (RCE) packets that span a particular time, such as a time T_{ac} equal to one cycle of an AC component existing in the communication channel. Upon receiving the N RCE packets, node 2 determines at 704 a transmission scheme tone map start TMS that is advantageous or optimized for each RCE packet and selects at 704 one scheme, such as the one corresponding to the median, minimum, or maximum Physical Layer (PHY) rate. The tone map start TMS may be a packet carrying data (e.g., data unknown to the receiver) that is robustly modulated or a packet carrying a special training sequence that is known to the receiver so as to improve the accuracy of the channel estimation. Node 2 communicates at 706 an indication of the selected transmission scheme TMS back to node 1 with a Channel Estimation Respond (CER) packet. Alternatively, node 2 may communicate each of the determined tone map starts TMSs back to node 1 in a CER packet and node 1 may select the one scheme from the set of N transmission scheme tone map starts TMSs.

Node 1 sets at 708 a counter j to an initial value of one and associates at 710 the selected TMS with two time values for the next packet Pⱼ to be transmitted: (1) the time offset Toⱼ between the start of a beacon signal and the start of packet Pⱼ and (2) the duration Tpⱼ of the transmitted packet Pⱼ. Node 1 transmits at 712 to node 2 packet Pⱼ using the selected TMS. Node 2 receives at 714 packet Pⱼ, determines at 716 an improved transmission scheme TMOⱼ on the basis of received packet Pⱼ, and compares TMOⱼ to the selected TMS to determine at 718 a partial tone map PTMⱼ. Node 2 sends at 720 to node 1, in an acknowledgment packet ACKⱼ, the determined partial tone map PTMⱼ (e.g., a list of a subset of carriers that require a different modulation scheme). For example, node 2 could feed back information regarding the 10, 20, or 50 carriers that exhibited the largest Signal-To-Noise-Ratio (SNR) difference between TMS and TMOⱼ. Note that the receiver can decide on a case by case basis not to feed back a partial tone map PTM if it determines that a simple change in the FEC rate produces an acceptable PHY rate decrease. In fact, this choice is more convenient as less overhead would be used than in the case of feeding back a partial tone map PTM.

Node 1 uses the received ACKⱼ packet to update the selected TMS with PTMⱼ and thereby generate at 722 an updated tone map TMⱼ that is associated at 724 with Toⱼ and Tpⱼ. Note that TMⱼ may not be optimal (as may be TMOⱼ) since it was updated on the basis of a partial tone map. Updated tone map TMⱼ will be used for a future packet of duration Tpⱼ transmitted at a time offset from the beacon equal to To=Toⱼ+k×Tac, where k is integer. For example, see packet P4, in FIG. 3, which is transmitted at To4=To1+Tac using TM1=TMS+PTM1.

Node 1 increments 726 counter j by one and determines at 728 whether the value of counter j exceeds N. Operations 710-726 are repeated at 728 until the value of counter j exceeds N, such that node 1 has created N packets using the selected TMS and N improved tone maps and their associated offsets and lengths (i.e., {TM1, To1, Tp1}, {TM2, To2, Tp2}, and {TM3, To3, Tp3}). FIG. 3 illustrates an example of method 700 for the case of Tb=3Tac and N=3, where Tac is the AC cycle duration and Tb is the beacon interval.

Once the value of counter j exceeds N, node 1 associates at 730 the next packet's, Pⱼ's, time offset Toⱼ and transmission duration Tpⱼ with TM_{j-N}. Node 1 transmits at 732 packet Pⱼ to node 2 using TM_{j-N}. Node 2 receives at 734 packet Pⱼ, determines at 736 an improved transmission scheme TMOⱼ on the basis of received packet Pⱼ, and compares TMOⱼ to TM_{j-N} to determine at 738 a partial tone map PTMⱼ. Node 2 sends at 740 to node 1 in an acknowledgment packet ACKⱼ the determined partial tone map PTMⱼ.

Node 1 uses the received ACK, packet to update TMⱼ₋N with PTMⱼ and thereby generate at 742 an updated tone map TMⱼ that is associated at 744 with Toⱼ and Tpⱼ. Node 1 increments at 746 counter j by one and determines at 748 whether any packets remain to be transmitted. If so, operations 730-746 are repeated at 748 until no further packets remain to be sent; otherwise, operation ceases.

To better understand method 700, Table 1 above tabulates a specific example of how the tone maps are generated and applied to the first ten packets transmitted from node 1 to node 2 when N=3.

As discussed expressly in the description for some embodiments and applicable to all embodiments, the information communicated in an acknowledgment message for use in generating a tone map or revising a previously generated tone map need not be a tone map or a partial tone map. Instead, this information may be an indicator of a tone map or partial tone map. The indicator may identify a tone map or partial tone map, which is to be applied in revising a tone map, or it may provide information for use in generating a tone map or partial tone map.

For example, two communicating nodes may both store a plurality of tone maps or partial tone maps that are each identified by a unique index number. In such a case, an acknowledgment message may communicate a particular index number to identify a tone map or partial tone map, rather than communicate the tone map or partial tone map, so as to increase the communication efficiency between the two nodes.

The foregoing description illustrates and describes the present invention. However, the disclosure shows and describes only the preferred embodiments of the invention, but it is to be understood that the invention is capable of use in various other combinations, modifications, and environments. Also, the invention is capable of change or modification, within the scope of the inventive concept, as expressed herein, that is commensurate with the above teachings and the skill or knowledge of one skilled in the relevant art. For example, one or more elements of each embodiment may be omitted or incorporated into the other embodiments.

The foregoing description of implementations and embodiments of the invention have been presented for purposes of non-limiting illustration and description. Although the present invention has been described herein with reference to particular structures, materials and embodiments, the present invention is not intended to be limited to the particular features and details disclosed herein. Rather, the present invention extends to all functionally equivalent structures, methods and uses, such as are within the scope of the appended claims. The descriptions provided herein are not exhaustive and do not limit the invention to the precise forms disclosed. The foregoing embodiment examples have been provided merely for purposes of explanation and are in no way to be construed as limiting the scope of the present invention. The words that have been used herein are words of description and illustration, rather than words of limitation. The present teachings can readily be realized and applied to other types of apparatuses. Further, modifications and variations, within the purview, scope and sprit of the appended claims and their equivalents, as presently stated and as amended hereafter, are possible in light of the above teachings or may be acquired from practicing the invention. Furthermore, although elements of the invention may be described or claimed in the singular, the plural is contemplated unless limitation to the singular is explicitly stated Alternative structures discussed for the purpose of highlighting the invention's advantages do not constitute prior art unless expressly so identified. No one or more features of the present invention are necessary or critical unless otherwise specified.

What is claimed is:

1. A communication device for communicating over a communication channel, said communication device comprising:
a transmitter that transmits over said channel to a second communication device a first packet P1, employing a starting tone map TMS comprising a starting transmission scheme for a set of carriers of said channel;
a receiver that receives over said channel a partial tone map PTM1 or an indicator thereof from said second communication device; and
a tone map generator that generates an updated tone map TM1 based on said starting tone map TMS and said partial tone map PTM1 or said indicator thereof, wherein:
said transmitter transmits over said channel a second packet P2 to said second communication device, employing said updated tone map TM1.

2. The communication device of claim 1, further comprising:
a memory that stores a partial tone map PTM1, wherein said tone map generator retrieves said partial tone map PTM1 from said memory based on said indicator of partial tone map PTM1 and modifies said starting tone map TMS with information of said partial tone map PTM1.

3. The communication device of claim 1, wherein said partial tone map PTM1 or said indicator thereof is received as part of an acknowledgment packet from said second communication device.

4. A method of communicating over a communication medium having a periodically varying channel, said method comprising:
determining a starting tone map TMS comprising a starting transmission scheme for a set of carriers of said channel;
transmitting at the first communication device a first packet P1 employing said starting tone map TMS;
receiving said first packet P1 at a second communication device;
determining a tone map TMO1 based on characteristics of said packet P1 received at said second communication device, said tone map TMO1 comprising transmission schemes for said set of carriers of said channel;
comparing said tone map TMO1 with said starting tone map TMS to determine a partial tone map PTM1 comprising transmission schemes for a subset of said carriers of said channel that are different from the starting transmission scheme of said starting tone map TMS;
generating an updated tone map TM1 based on said starting tone map TMS modified in accordance with said partial tone map PTM1;
associating said updated tone map TM1 with a time offset To1 between a start time of a communication period and a start time of said first packet P1 and a time value Tp1 comprising a time duration to transmit said first packet P1; and
employing said updated tone map TM1 to transmit at the first communication device a packet to the second communication device.

5. The method of claim 4, wherein said packet transmitted by employing said updated tone map TM1 has a time duration equal to said time value Tp1 and is transmitted at a time offset from said start time of said communication period equal to said time value To1+j×L, where j is an integer and L is a variation cycle of characteristics of said periodically varying channel.

6. The method of claim 4, further comprising:
transmitting at the first communication device a second packet P2 employing said starting tone map TMS;
receiving said second packet P2 at said second communication device;
determining a tone map TMO2 based on characteristics of said second packet P2 received at said second communication device, said tone map TMO2 comprising transmission schemes for said set of carriers of said channel;
comparing said tone map TMO2 with said starting tone map TMS to determine a partial tone map PTM2 comprising transmission schemes for a subset of said carriers of said channel that are different from the starting transmission scheme of said starting tone map TMS;
generating an updated tone map TM2 based on said starting tone map TMS modified in accordance with said partial tone map PTM2;
associating said updated tone map TM2 with a time offset To2 between a start time of said communication period and a start time of said second packet P2 and a time value Tp2 comprising a time duration to transmit said second packet P2; and
employing said updated tone map TM2 to transmit a packet to the second communication device.

7. The method of claim 6, wherein said packet transmitted by employing said updated tone map TM2 has a time duration equal to said time value Tp2 and is transmitted at a time offset from said start time of said communication period equal to To2+j×L.

8. The method of claim 4, further comprising:
transmitting at the first communication device another packet P employing said updated tone map TM1;
receiving said packet P at the second communication device;
determining a tone map TMO based on characteristics of said packet P received at said second communication device, said tone map TMO comprising transmission schemes for said set of carriers of said channel;
comparing said tone map TMO with said tone map TM1 to determine a partial tone map PTM comprising transmission schemes for a subset of said carriers of said channel that are different from the transmission scheme of said tone map TM1;
updating said tone map TM1 based on said partial tone map PTM to generate an updated tone map TM;
associating said updated tone map TM with said time offset To1 and said time value Tp1; and
employing said updated tone map TM to transmit at the first communication device a packet to said second communication device.

9. The method of claim 8 wherein said packet transmitted by employing said updated tone map TM has a time duration equal to said time value Tp1 and is transmitted at a time offset from said start time of said communication period equal to said time value To1+(j+1)×L.

10. The method of claim 4, further comprising setting said communication period to L×N to perform communications over said channel, wherein N is an integer≧1.

11. The method of claim 4, wherein said step of determining said tone map TMO1 is based on a moving average of packet characteristics over a plurality of said variation cycles.

12. The method of claim 4, further comprising setting said communication period to L×N to perform communications over said channel, wherein N is a non-integer>1.

13. The method of claim 4, wherein the network is a power line communication network, the shared communication medium is an AC power line, and the characteristics of the channel vary with the phase of the AC line cycle.

14. The method of claim 4, wherein said partial tone map PTM1 or an indicator thereof is transmitted to said first communication device in an ACK packet from said second communication device.

15. The method of claim 4, further comprising changing a duration of a frame employed by said first communication device.

16. The method of claim 4, further comprising modifying the strength of FEC in response to a detection at said second communication device that noise increases or decreases between a start time and an end time of a received packet.

17. The method of claim 4, wherein said step of determining tone map TMO1 comprises modifying reliance on symbols in a preamble and a postamble of a received packet in response to a detection at said second communication device that noise increases or decreases between a start time and an end time of the received packet.

18. The method of claim 4, wherein said communication channel is a channel shared by a plurality of communication devices and said method further comprises generating at a third communication device a starting tone map for communication between said third communication device and one of said first communication device and said second communication device based on packets exchanged by said first communication device and said second communication device and observed by said third communication device.

19. A method of communicating over a communication channel, said method comprising:
determining a starting tone map TMS comprising a starting transmission scheme for a set of carriers of said channel;
transmitting at the first communication device a packet P1 employing said starting tone map TMS;
receiving said packet P1 at a second communication device;
determining a tone map TMO1 based on characteristics of said packet P1 received at said second communication device, said tone map TMO1 comprising transmission schemes for said set of carriers of said channel;
comparing said tone map TMO1 with said starting tone map TMS to determine a partial tone map PTM1 comprising transmission schemes for a subset of said carriers of said channel that are different from the starting transmission scheme of said starting tone map TMS;
transmitting said partial tone map PTM1 or an indicator thereof to said first communication device;
generating an updated tone map TM1 based on said starting tone map TMS modified in accordance with said partial tone map PTM1; and
employing said updated tone map TM1 to transmit a packet at the first communication device.

20. The method of claim 19, further comprising:
transmitting at the first communication device another packet P employing said updated tone map TM1;
receiving said packet P at a second communication device;
determining a tone map TMO based on characteristics of said packet P received at said second communication device, said tone map TMO comprising transmission schemes for said set of carriers of said channel;
comparing said tone map TMO with said tone map TM1 to determine a partial tone map PTM comprising transmission schemes for a subset of said carriers of said channel that are different from the transmission scheme of said tone map TM1;
updating said tone map TM1 based on said partial tone map PTM to generate an updated tone map TM; and
employing said updated tone map TM to transmit a packet at the first communication device.

21. The method of claim 19, wherein the network is a power line communication network, and the shared communication medium is provided by an DC power line.

22. The method of claim 19, wherein said partial tone map PTM or an indicator thereof is transmitted to said first communication device in an ACK packet.

23. The method of claim 19, further comprising setting a communication period to perform communications over said channel.

24. The method of claim 19, wherein said packet P1 comprises pilot symbols spaced across said packet P1.

25. A system of communicating over a medium having a periodically varying channel, said system comprising:
a first communication device that transmits a first packet P1 employing a starting tone map TMS that has associated therewith a time offset To1 between a start time of a communication period and a start time of said first packet P1 and a time value Tp1 comprising a time duration to transmit said first packet P1;
a second communication device that receives said first packet P1;
a determiner that (i) determines a tone map TMO1 based on characteristics of said packet P1 received at said second communication device, said tone map TMO1 comprising transmission schemes for a set of carriers of said channel, (ii) compares said tone map TMO1 with said starting tone map TMS to determine a partial tone map PTM1 comprising transmission schemes for a subset of said carriers of said channel that are different from the starting transmission scheme of said starting tone map TMS, and (iii) determines an updated tone map TM1 based on said starting tone map TMS modified in accordance with said partial tone map PTM1, wherein:
said updated tone map TM1 is associated with said time offset To1 and said time value Tp1; and
said first communication device employs said updated tone map TM1 to transmit a packet to said second communication device.

26. The system of claim 25, wherein said packet transmitted by employing said updated tone map TM1 has a time duration equal to said time value Tp1 and is transmitted at a time offset from said start time of said communication period equal to said time value To1+j×L, where j is an integer and L is a variation cycle of characteristics of said periodically varying channel.

27. The system of claim 25, wherein:
the first communication device transmits a second packet P2 employing said starting tone map TMS;
said second communication device receives said second packet P2;
said determiner (i) determines a tone map TMO2 based on characteristics of said packet P2 received at said second communication device, said tone map TMO2 comprising transmission schemes for said set of carriers of said channel, (ii) compares said tone map TMO2 with said starting tone map TMS to determine a partial tone map PTM2 comprising transmission schemes for a subset of said carriers of said channel that are different from the starting transmission scheme of said starting tone map TMS, and (iii) determines an updated tone map TM2 based on said starting tone map TMS modified in accordance with said partial tone map PTM2, wherein:
said updated tone map TM2 is associated with a time offset To2 between a start time of said communication period and a start time of said second packet P2 and a time value Tp2 comprising a time duration to transmit said second packet P2; and
said first communication device employs said updated tone map TM2 to transmit a packet

28. The system of claim 27, wherein said packet transmitted by employing said updated tone map TM2 has a time duration equal to said time value Tp2 and is transmitted at a time offset from said start time of said communication period equal to To2+j×L.

29. The system of claim 25, wherein:
the first communication device transmits another packet P employing said updated tone map TM1;
said second communication device receives said packet P;
said determiner (i) determines a tone map TMO based on characteristics of said packet P received at said second communication device, said tone map TMO comprising transmission schemes for said set of carriers of said channel, (ii) compares said tone map TMO with said tone map TM1 to determine a partial tone map PTM comprising transmission schemes for a subset of said carriers of said channel that are different from the transmission scheme of said tone map TM1, and (iii) updates said tone map TM1 based on said partial tone map PTM to generate an updated tone map TM;
said updated tone map TM is associated with said time offset To1 and said time value Tp1; and
said first communication device employs said updated tone map TM to transmit a packet to said second communication device.

30. The system of claim 29, wherein said packet transmitted by employing said updated tone map TM has a time duration equal to said time value Tp1 and is transmitted at a time offset from said start time of said communication period equal to said time value To1+(j+1)×L.

31. The method of claim 25, wherein said communication period is set to L×N to perform communications over said channel and N is an integer≧1.

32. The method of claim 25, wherein said step of determining said tone map TMO1 is based on a moving average of packet characteristics over a plurality of cycles of said periodically varying channel.

33. The method of claim 25, wherein said communication period is set to L×N to perform communications over said channel and N is a non-integer>1.

34. A system of operating in a network in which a plurality of communication devices communicate over a shared communication channel, said system comprising:
a first communication device that transmits a packet P1 employing a starting tone map TMS comprising a starting transmission scheme for a set of carriers of said channel; and
a second communication device that receives said packet P1, wherein:
said first communication device employs an updated tone map TM1 to transmit a packet, said updated tone map being provided by:
determining a tone map TMO1 based on characteristics of said packet P1 received at said second communication device, said tone map TMO1 comprising transmission schemes for said set of carriers of said channel;
comparing said tone map TMO1 with said starting tone map TMS to determine a partial tone map PTM1 comprising transmission schemes for a subset of said carriers of said channel that are different from the starting transmission scheme of said starting tone map TMS; and
generating said updated tone map TM1 based on said starting tone map TMS modified in accordance with said partial tone map PTM1.

35. The system of claim 34, wherein:
the first communication device transmits another packet P employing said updated tone map TM1;
second communication device receives said packet P, wherein:
said first communication device employs said updated tone map TM to transmit another packet, said updated tone map TM being provided by:
determining a tone map TMO based on characteristics of said packet P received at said second communication device, said tone map TMO comprising transmission schemes for said set of carriers of said channel;
comparing said tone map TMO with said tone map TM1 to determine a partial tone map PTM comprising transmission schemes for a subset of said carriers of said channel that are different from the transmission scheme of said tone map TM1; and
updating said tone map TM1 based on said partial tone map PTM to generate an updated tone map TM.

36. The system of claim 34, wherein the network is a power line communication network, and the shared medium is an DC power line.

37. The system of claim 34, wherein said partial tone map PTM or an indicator thereof is transmitted to said first communication device in an ACK packet.

38. The method of claim 4, wherein said packet P1 comprises pilot symbols spaced across said packet P1.

39. A method of communicating over a communication medium having a periodically time varying channel, said method comprising:
transmitting at the first communication device a first packet P(i) employing a transmission scheme TM(i) and associating to TM(i) the corresponding time instant To(i) when said packet P(i) was transmitted;
transmitting at the first communication device a second packet P(i+1) employing a transmission scheme TM(i+1) at a time instant T(i+1) that is equal to or approximately equal to To(i)+L, where L is a variation cycle of characteristics of said periodically varying channel;
receiving said first packet P(i) at a second communication device and generating an updated transmission scheme TMU based on said received packet P(i);
transmitting to said first communication device said updated transmission scheme TMU or an indicator thereof; and
generating at the first communication device said transmission scheme TM(i+1) on the basis of said TM(i) and on said received updated transmission scheme TMU,
wherein said updated transmission scheme TMU is transmitted in part to said first communication device.

40. The method of claim 39, further comprising setting a communication period to L×N to perform communications over said periodically time varying channel, N is a non-integer greater than 1, and determining a relationship between a time offset of a new packet transmission start time in a new communication period and a time offset of a previous packet transmission start time in a previous communication period, wherein said new packet transmission start time and said previous packet transmission start time are located at approximately the same phase in said periodically time varying channel.

41. The method of claim 39, wherein said updated transmission scheme TMU is transmitted to said first communication device using an acknowledgment packet.
